(19) United States
(12) Patent Application Publication
(10) Pub. No.: US 2013/0301762 A1
(43) Pub. Date: Nov. 14, 2013

(54) RECEPTION APPARATUS AND RECEPTION METHOD

(71) Applicant: FUJITSU LIMITED, Kawasaki-shi (JP)

(72) Inventor: Shunji MIYAZAKI, Kawasaki (JP)

(21) Appl. No.: 13/851,799

(22) Filed: Mar. 27, 2013

(30) Foreign Application Priority Data
May 8, 2012 (JP) 2012-107126

(51) Int. Cl. H04L 1/00

(52) U.S. Cl. CPC H04L 1/0054
USPC 375/341

(57) ABSTRACT

A reception apparatus including: a receiver configured to receive a symbol including a plurality of bits and to calculate each of likelihoods for each of the plurality of bits, and a processor configured to quantize each of the likelihoods based on each of numbers of quantization bits for each of the plurality of bits, wherein all of the numbers of quantization bits are not same.

### CROSS-REFERENCE TO RELATED APPLICATION

This application is based upon and claims the benefit of priority of the prior Japanese Patent Application No. 2012-107126, filed on May 8, 2012, the entire contents of which are incorporated herein by reference.

### FIELD

The embodiments discussed herein are related to a reception apparatus and a reception method.

### BACKGROUND

In digital communication systems, transmission apparatuses perform error detection coding and error correction coding to digital data, perform digital modulation to the digital data, and output the digital data on transmission channels. On the transmission channels, signal distortion occurs due to the effect of noise or the like. Reception apparatuses receive the signals from the transmission channels and demodulate the reception signals to generate likelihood data corresponding to the signal levels. The reception apparatuses decode the likelihood data to acquire the original digital data. In such cases, soft decision data represented in multiple levels may be used as the likelihood data supplied as inputs in the decoding, instead of hard decision data represented by two values: zero and one. The use of the soft decision data improves the error correction capability in the decoding.

For example, refer to Japanese Laid-open Patent Publication No. 2008-153751, Japanese Laid-open Patent Publication No. 2010-154144, and Japanese Laid-open Patent Publication No. 4-79647.

### SUMMARY

According to an aspect of the invention, a reception apparatus including: a receiver configured to receive a symbol including a plurality of bits and to calculate each of likelihoods for each of the plurality of bits, and a processor configured to quantize each of the likelihoods based on each of numbers of quantization bits for each of the plurality of bits, wherein all of the numbers of quantization bits are not same.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of multi-level modulation.

FIG. 2 illustrates an example of the value of a zeroth bit of each symbol and a reception symbol in 16QAM illustrated in, for example, FIG. 1.

FIG. 3 illustrates an example of the value of a second bit of each symbol and the reception symbol in the 16QAM illustrated in, for example, FIG. 1.

FIG. 4 illustrates an exemplary configuration of a communication system of a first embodiment.

FIG. 5 illustrates an example of a transmission apparatus of the first embodiment.

FIG. 6 illustrates an example of a reception apparatus of the first embodiment.

FIG. 7 illustrates an exemplary hardware configuration of the transmission apparatus.

FIG. 8 illustrates an exemplary hardware configuration of the reception apparatus.

FIG. 9 is a flowchart illustrating an exemplary operational process performed by the reception apparatus of the first embodiment.

FIG. 10 illustrates an example of 64QAM.

FIG. 11 illustrates an example of a reception apparatus of a second embodiment.

FIG. 12 illustrates an example of block error rates (BLERs) when the number of quantization bits is varied.

FIG. 13 illustrates an example of a reception apparatus of a third embodiment.

FIG. 14 is a graph illustrating the relationship between a coding rate and an amount of signal degradation.

FIG. 15 illustrates an example of a reception apparatus of a fourth embodiment.

FIG. 16 illustrates an example of a transmission apparatus of a fifth embodiment.

FIG. 17 illustrates an example of a reception apparatus of the fifth embodiment.

FIG. 18 is a flowchart illustrating an exemplary operational process performed by the reception apparatus of the fifth embodiment.

FIG. 19 illustrates an example of a reception apparatus of a sixth embodiment.

### DESCRIPTION OF EMBODIMENTS

In a decoding process in a reception apparatus, the reception apparatus temporarily stores quantized data resulting from quantization of a reception signal in an intermediate buffer. Then, the reception apparatus reads out the quantized data from the intermediate buffer to decode the quantized data. In order not to cause characteristic degradation of signals, it is desirable to increase the number of quantization bits in the quantized data. However, the increase in the number of quantization bits in the quantized data increases the circuit size of the intermediate buffer. In general, the circuit sizes of apparatuses are preferably small. Accordingly, it is desirable to decrease the number of quantization bits in the quantized data while suppressing the characteristic deterioration of signals.

A technology disclosed in the present disclosure is provided to decrease the number of quantization bits in the quantization.

Embodiments of the present disclosure will herein be described with reference to the attached drawings. While the present disclosure is described in terms of some specific embodiments, it will be clear that this present disclosure is not limited to these specific configurations in the embodiments and that the specific configurations according to embodiments may be arbitrarily adopted in the present disclosure.

For example, Long Term Evolution (LTE) on 3rd Generation Partnership Project (3GPP) is assumed as a communication system here. The embodiments of the present disclosure are not limited to the communication system, such as the LTE on the 3GPP, and are applicable to other communication systems.

### Multi-Level Modulation

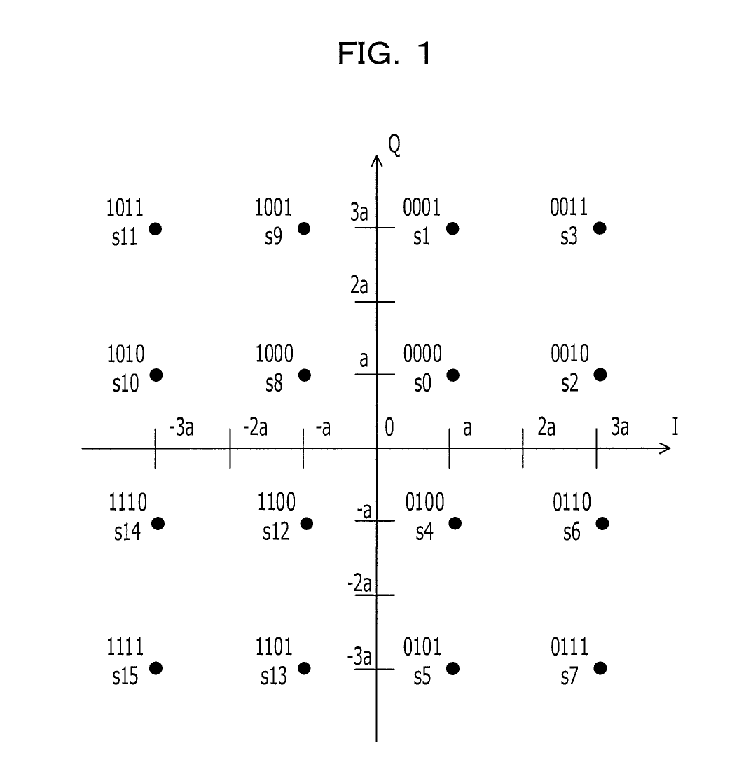

FIG. 1 illustrates an example of multi-level modulation. The example in FIG. 1 is an example of 16 quadrature amplitude modulation (16QAM). Symbols in the 16QAM are represented by black circles in FIG. 1.

In the 16QAM, four-bit data is allocated each of 16-type combinations of phase and amplitude. Such combinations are called the symbols. The phase and the amplitude are represented by an I component and a Q component, respectively, in a complex plane (IQ plane). In the example in FIG. 1, a symbol of four-bit data “0000” is positioned at (a, a) on the IQ plane. Here, the respective bits of the four-bit data represented by one symbol are called a zeroth bit, a first bit, a second bit, and a third bit, from the left side. A transmission apparatus maps data for every four bits on one symbol in the manner illustrated in FIG. 1, performs digital-analog (D/A) conversion or the like to the data, and transmits the signal to a reception apparatus.

### Likelihood

A likelihood of a bit is a scale representing the likelihood that the bit has a value of zero (or a value of one). The likelihood of a bit is defined in a manner in which the positive or negative sign bit corresponds to a hard decision bit and in which the absolute value of its amplitude represents the likelihood that the hard decision bit is the bit that has actually been transmitted. Accordingly, a hard decision bit of zero and a low value of amplitude mean that, “although the possibility that the hard decision bit is equal to one is not high and the possibility that the hard decision bit is equal to zero is higher than the possibility that the hard decision bit is equal to one, the possibility that the hard decision bit is equal to zero is not definite”. The likelihood is calculated for each bit included in one symbol.

The reception apparatus performs processing, such as Analog-to-digital (A/D) conversion and synchronous detection, to a signal that is received to acquire the position of a reception symbol on the IQ plane from the amplitude and the phase of the reception signal. The position of the reception symbol is ideally the same as the position of the symbol in the transmission apparatus. The synchronous detection has a role to perform phase estimation to a reception symbol that results from rotation of the phase of a transmission symbol by phasing or the like and that is received to return the rotated phase to the original position on the basis of the information in the phase estimation. However, the position of the reception symbol is normally different from the position of the symbol in the transmission apparatus due to the effects of noise on a channel, noise in an internal circuit of the reception apparatus, and so on.

The likelihood of a bit is, for example, the difference between a shortest distance (denoted by X1), among the distances between the reception symbol and symbols the bit of which have a value of one, and a shortest distance (denoted by X0), among the distances between the reception symbol and symbols the bit of which have a value of zero. In other words, the likelihood of a bit is equal to X1²−X0². The distances here are square distances. The likelihood of a bit is increased with the increasing X1 and with the decreasing X0. The likelihood of a bit may be equal to X1−X0. Provided that the likelihood of the bit is equal to −(X1²−X0²) or −(X1−X0), the likelihood of a bit is a scale representing the likelihood that the bit has a value of one.

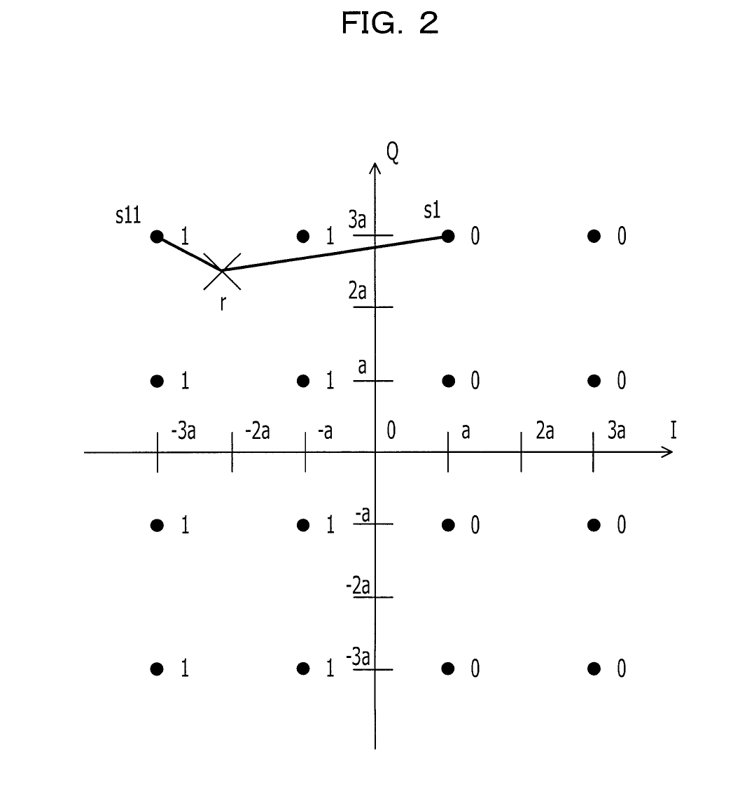

FIG. 2 illustrates an example of the value of the zeroth bit of each symbol and the reception symbol in the 16QAM illustrated in, for example, FIG. 1. In FIG. 2, the reception symbol is denoted by r. In the example in FIG. 2, “0” or “1” representing the value of the zeroth bit is described near each symbol represented by a black circle. The likelihood of the zeroth bit is the difference between a shortest distance, among the distances between the reception symbol r and symbols the zeroth bit of which have a value of one, and a shortest distance, among the distances between the reception symbol r and symbols the zeroth bit of which have a value of zero. In other words, the likelihood of the zeroth bit is the difference between the distance between the reception symbol r and a symbol s11 and the distance between the reception symbol r and a symbol s1. In the example in FIG. 2, a mean (square) distance between the symbols the zeroth bits of which have a value of zero and the symbols the zeroth bits of which have a value of one is longer than a mean (square) distance between the symbols the second bits of which have a value of zero and the symbols the second bits of which have a value of one. Accordingly, the distribution of the likelihoods of the zeroth bit is wider than the distribution of the likelihoods of the second bit.

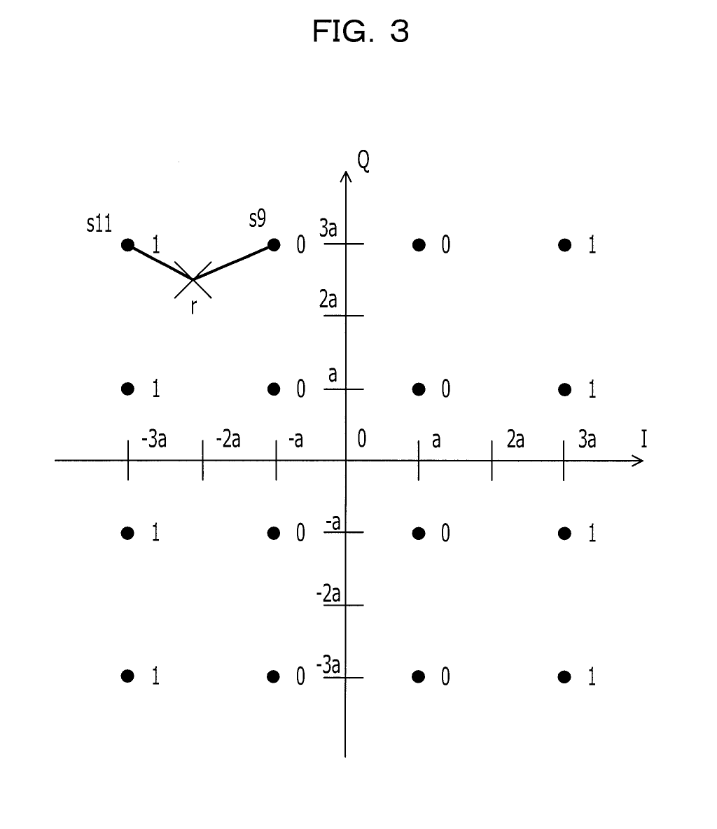

FIG. 3 illustrates an example of the value of the second bit of each symbol and the reception symbol in the 16QAM illustrated in, for example, FIG. 1. In FIG. 3, the reception symbol is denoted by r. In the example in FIG. 3, “0” or “1” representing the value of the second bit is described near each symbol represented by a black circle. The likelihood of the second bit is the difference between a shortest distance, among the distances between the reception symbol r and symbols the second bit of which have a value of one, and a shortest distance, among the distances between the reception symbol r and symbols the second bit of which have a value of zero. In other words, the likelihood of the second bit is the difference between the distance between the reception symbol r and the symbol s11 and the distance between the reception symbol r and a symbol s9. In the example in FIG. 3, the symbols the second bits of which have a value of “1” exist near the symbols the second bit of which have a value of “0”. Accordingly, it is assumed that the distribution of the likelihoods of the second bit is narrower than the distribution of the likelihoods of the zeroth bit.

In the 16QAM illustrated in, for example, FIG. 1, since the arrangement of “0” and “1” on the IQ plane of the zeroth bit is the same as the arrangement of “0” and “1” on the IQ plane of the first bit, the distribution of the likelihoods of the zeroth bit is similar to that of the first bit. Similarly, since the arrangement of “0” and “1” on the IQ plane of the second bit is the same as the arrangement of “0” and “1” on the IQ plane of the third bit, the distribution of the likelihoods of the second bit is similar to that of the third bit. In contrast, since the arrangement of “0” and “1” on the IQ plane of the zeroth bit is different from the arrangement of “0” and “1” on the IQ plane of the second bit, the distribution of the likelihoods of the zeroth bit is different from that of the second bit. Similarly, since the arrangement of “0” and “1” on the IQ plane of the first bit is different form the arrangement of “0” and “1” on the IQ plane of the third bit, the distribution of the likelihoods of the first bit is different from that of the third bit.

The distribution of the likelihoods depends on the arrangement of the symbols the bit of which have a value of “0” and the arrangement of the symbols the bit of which have a value of “1”. In the example in FIG. 1, the distribution of the likelihoods of the zeroth bit is wider than the distribution of the likelihoods of the second bit. In other words, the dynamic range of the distribution of the likelihoods of the zeroth bit is wider than the dynamic range of the distribution of the likelihoods of the second bit. When the dynamic range of the distribution of the likelihoods is narrow, the number of quantization bits of the likelihoods may be small. If the same number of quantization bits is used, high-order bits are often not used (are often equal to zero) in the values after the quantization of bits having a narrow dynamic range of the distribution of the likelihoods. The distribution of the likelihoods depends on the arrangement of the bits (“0” and “1”).

Accordingly, in the reception apparatus, it is possible to make the numbers of quantization bits of the likelihood of the second bit and the likelihood of the third bit smaller than the numbers of quantization bits of the likelihood of the zeroth bit and the likelihood of the first bit while keeping the precision of the decoding.

The reception apparatus is an example of a quantization apparatus.

### First Embodiment

### Exemplary Configurations

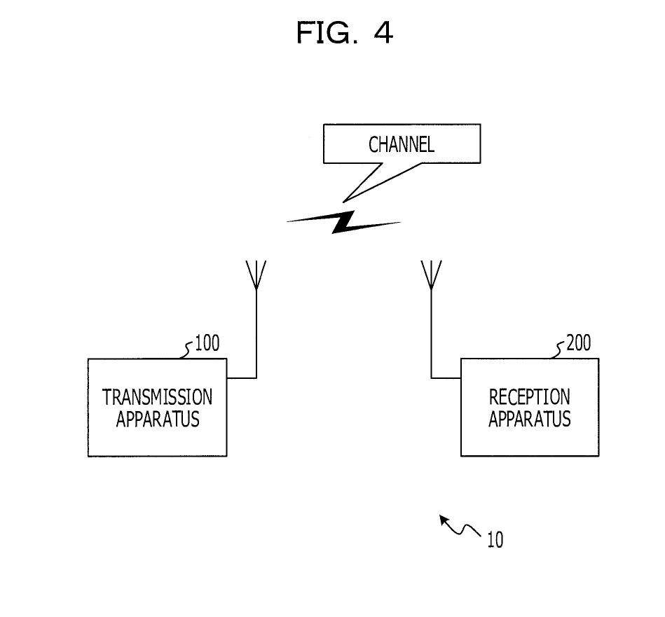

FIG. 4 illustrates an exemplary configuration of a communication system of a first embodiment. Referring to FIG. 4, a communication system 10 of the first embodiment includes a transmission apparatus 100 and a reception apparatus 200. The transmission apparatus 100 transmits data to the reception apparatus 200 via a channel. The data transmission is performed in units of frames each having a certain data length. The reception apparatus 200 decodes a signal received from the transmission apparatus 100.

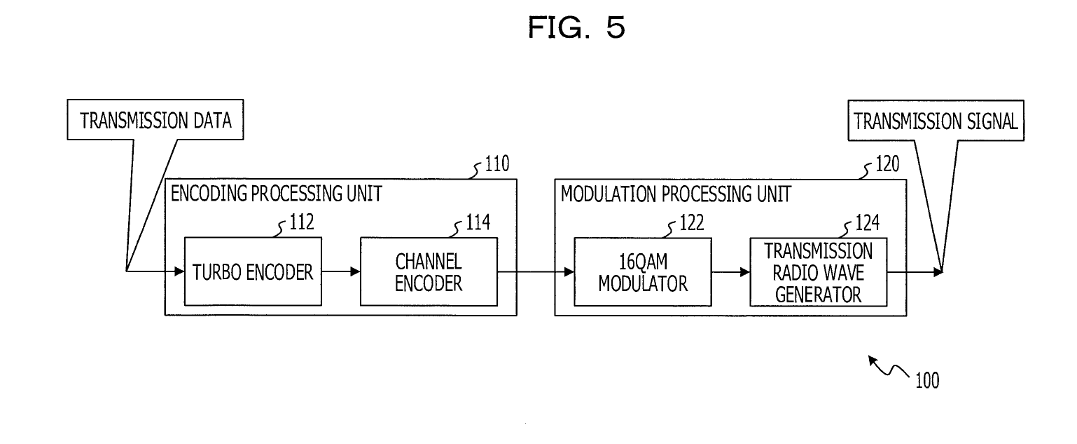

FIG. 5 illustrates an example of the transmission apparatus of the first embodiment. Referring to FIG. 5, the transmission apparatus 100 includes an encoding processing unit 110 and a modulation processing unit 120. The encoding processing unit 110 includes a turbo encoder 112 and a channel encoder 114. The channel encoder 114 performs, for example, a rate matching and an interleaving. The modulation processing unit 120 includes a 16QAM modulator 122 and a transmission radio wave generator 124.

The turbo encoder 112 in the encoding processing unit 110 performs turbo encoding to data to be transmitted (transmission data). The data to be transmitted may be divided into multiple packets to be subjected to the turbo encoding. Provided that the data to be transmitted (or one packet) has a size of K bits, an encoded bit size Nt=3×K+12 bits.

The channel encoder 114 in the encoding processing unit 110 performs rate matching so that the data subjected to the turbo encoding has a certain code length. Provided that the certain code length is denoted by Nd, a coding rate R=K/Nd. The data having the certain code length is also called a block. The encoding processing unit 110 performs interleaving in which the order of bit sequences is changed in a certain pattern before or after the rate matching.

The 16QAM modulator 122 in the modulation processing unit 120 performs 16QAM modulation to the output from the encoding processing unit 110. The 16QAM modulator 122 converts a signal that is input into one symbol for every four bits. As in the example in FIG. 1, the zeroth bit and the second bit are mapped as the I components and the first bit and the third bit are mapped as the Q components.

The transmission radio wave generator 124 in the modulation processing unit 120 converts the output from the 16QAM modulator 122 into a certain radio frequency and transmits the signal of the certain radio frequency to the reception apparatus 200 through the antenna or the like.

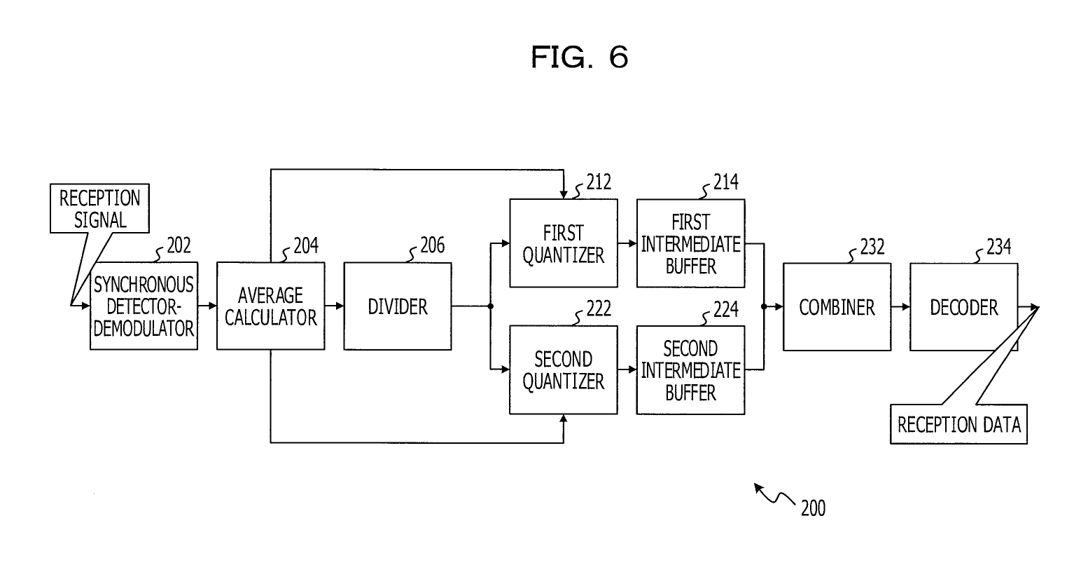

FIG. 6 illustrates an example of the reception apparatus of the first embodiment. Referring to FIG. 6, the reception apparatus 200 includes a synchronous detector-demodulator 202, an average calculator 204, a divider 206, a first quantizer 212, a first intermediate buffer 214, a second quantizer 222, a second intermediate buffer 224, a combiner 232, and a decoder 234.

The synchronous detector-demodulator 202 performs, for example, the synchronous detection to a reception signal received through an antenna or the like to acquire the reception symbol as a point on the IQ plane. The synchronous detector-demodulator 202 calculates the likelihood (soft decision data) of each bit in the reception symbol. The bit precision of the soft decision data is, for example, 32 bits. The likelihood of each bit is calculated by, for example, −(X0²−X1²), as described above.

The input data in demodulation is a symbol subjected to data reception processing, such as the synchronous detection, and is complex data in which the signal symbol that is transmitted is completely reproduced, except for the degree of freedom of the size of the amplitude, if no noise is added to the symbol on the channel. Since noise is generally added, the input data is one complex symbol shifted from a signal point. The complex symbol is used to generate the soft decision data corresponding to each encoded bit mapped on the transmission symbol.

The average calculator 204 calculates the average of the absolute values of the likelihoods of the respective bits calculated by the synchronous detector-demodulator 202. The average calculator 204 calculates the average of the absolute values in certain units. The certain unit is, for example, the certain code length Nd (block) set in the transmission apparatus 100. One reception symbol is divided into a first sub-block SB1 including the zeroth bit and the first bit and a second sub-block SB2 including the second bit and the third bit.

The average calculator 204 determines a first certain multiple of the average of the absolute values (the average of the absolute values×a first certain number) to be the maximum likelihood value of the bits in the first sub-block SB1. The average calculator 204 determines a second certain multiple of the average of the absolute values (the average of the absolute values×a second certain number) to be the maximum likelihood value of the bits in the second sub-block SB2. The first certain number/the second certain number is a power of two (2ⁿ (n is an integer)). Provided that the average of the absolute values is denoted by A and the first certain number is denoted by B, the maximum likelihood value of the bits in the first sub-block SB1 is equal to A×B and the maximum likelihood value of the bits in the second sub-block SB2 is equal to A×B/2ⁿ.

The maximum likelihood value of the bits in the first sub-block SB1 and the maximum likelihood value of the bits in the second sub-block SB2 determined by the average calculator 204 are supplied to the first quantizer 212 and the second quantizer 222, respectively.

The average calculator 204 may determine the maximum likelihood, among the likelihoods of the bits in the first sub-block SB1, to be the maximum likelihood value of the bits in the first sub-block SB1. The average calculator 204 may determine the maximum likelihood, among the likelihoods of the bits in the second sub-block SB2, to be the maximum likelihood value of the bits in the second sub-block SB2. The maximum likelihood value of the bits in each sub-block may be determined on the basis of the distribution of the likelihoods of the bits in each sub-block.

The divider 206 divides the likelihoods of the respective bits in each reception symbol into the first sub-block SB1 and the second sub-block SB2. The divider 206 supplies the first sub-block SB1 to the first quantizer 212. The divider 206 supplies the second sub-block SB2 to the second quantizer 222.

The first quantizer 212 quantizes the likelihood of each bit in the first sub-block SB1 calculated by the synchronous detector-demodulator 202 with a first number of quantization bits m.

The first intermediate buffer 214 stores quantized data about the likelihood of each bit in the first sub-block SB1 quantized by the first quantizer 212.

The second quantizer 222 quantizes the likelihood of each bit in the second sub-block SB2 with a second number of quantization bits m×n in the same manner as in the first quantizer 212.

The above-mentioned m and n are determined in advance on the basis of, for example, the sizes of the intermediate buffers and are stored in a storage unit or the like. The above-mentioned m and n may be determined on the basis of the distribution of the likelihoods of the bits. When the distribution of the likelihoods of the bits is narrow, high-order bits in the quantized data are often not used. Accordingly, making the numbers of quantization bits small allows the sizes of the intermediate buffers to be decreased. When n is not equal to zero, the first number of quantization bits is different from the second number of quantization bits. The numbers of quantization bits are smaller than the number of bits in the soft decision data.

The second intermediate buffer 224 stores the quantized data about the likelihood of each bit in the second sub-block SB2 quantized by the second quantizer 222. When n is not equal to zero, the size of the first intermediate buffer 214 is different from the size of the second intermediate buffer 224. When n is equal to a positive number, the size of the second intermediate buffer 224 is smaller than the size of the first intermediate buffer 214. In other words, the size of the second intermediate buffer 224 may be equal to (m−n)/m multiple of the size of the first intermediate buffer 214. The number of the likelihoods of the bits stored in the first intermediate buffer 214 is the same as that in the second intermediate buffer 224.

The combiner 232 reads out the likelihood of the zeroth bit and the likelihood of the first bit from the first intermediate buffer 214 and reads out the likelihood of the second bit and the likelihood of the third bit from the second intermediate buffer 224. The combiner 232 serially combines the likelihoods of the bits from the zeroth bit to the third bit, which have been read out, with each other. The combiner 232 performs bit adjustment in the combination so that the pieces of quantized data are represented in the same manner.

The decoder 234 performs error correction decoding by using the quantized data combined by the combiner 232 to estimate the transmission data.

The first sub-block SB1 may be replaced with the second sub-block SB2.

The transmission apparatus 100 and the reception apparatus 200 may be realized by using a dedicated or general-purpose computer or by using an electronic device on which a computer is installed.

The computer, that is, an information processing apparatus includes a processor, a main memory, and a secondary storage and/or an interface unit with peripheral apparatuses, such as a communication interface unit. The storage units (the main memory and the secondary storage) are computer-readable recording media.

The computer is capable of realizing a function matched with a desired purpose with the processor that loads programs stored in the recording medium into a working area in the main memory and executes the programs to control a peripheral device through the execution of the programs.

The processor is, for example, a central processing unit (CPU) or a data signal processor (DSP). The main memory includes, for example, a random access memory (RAM) and a read only memory (ROM).

The secondary storage is, for example, an erasable programmable ROM (EPROM) or a hard disk drive. The secondary storage may include a removable medium, that is, a portable recording medium. The removable medium is, for example, a Universal Serial Bus (USB) memory or a disk recording medium, such as a compact disk (CD) or a digital versatile disk (DVD).

The communication interface unit is, for example, a local area network (LAN) interface board or a wireless communication circuit for wireless communication.

The peripheral apparatuses include input devices, such as a keyboard and a pointing device, and output devices, such as a display and a printer, in addition to the secondary storage and the communication interface unit. The input devices may include a video and image input device, such as a camera, and an audio input device, such as a microphone. The output devices may include an audio output device, such as a speaker.

The series of processing may be executed by hardware or may be executed by software.

The steps describing the programs include processes performed in time series according to the described order and also include processes performed in parallel or individually performed.

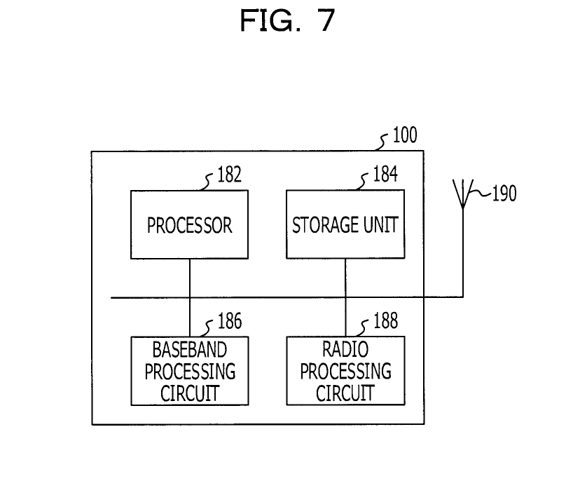

FIG. 7 illustrates an exemplary hardware configuration of the transmission apparatus. Referring to FIG. 7, the transmission apparatus 100 includes a processor 182, a storage unit 184, a baseband processing circuit 186, a radio processing circuit 188, and an antenna 190. The processor 182, the storage unit 184, the baseband processing circuit 186, the radio processing circuit 188, and the antenna 190 are connected to each other via, for example, a bus.

The processor 182 may function as the turbo encoder 112 and the channel encoder 114.

The storage unit 184 stores the programs executed by the processor 182, data used in the execution of the programs, and so on.

The baseband processing circuit 186 may function as the 16QAM modulator 122. The baseband processing circuit 186 processes a baseband signal.

The radio processing circuit 188 may function as the transmission radio wave generator 124. The radio processing circuit 188 processes a radio signal transmitted and received through the antenna 190.

The antenna 190 transmits the transmission signal processed by the radio processing circuit 188 and so on.

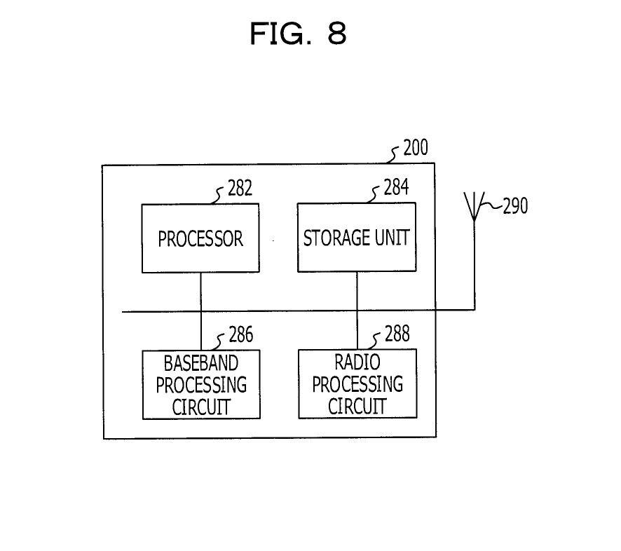

FIG. 8 illustrates an exemplary hardware configuration of the reception apparatus. Referring to FIG. 8, the reception apparatus 200 includes a processor 282, a storage unit 284, a baseband processing circuit 286, a radio processing circuit 288, and an antenna 290. The processor 282, the storage unit 284, the baseband processing circuit 286, the radio processing circuit 288, and the antenna 290 are connected to each other via, for example, a bus.

The processor 282 may function as the average calculator 204, the divider 206, the first quantizer 212, the first intermediate buffer 214, the combiner 232, and the decoder 234.

The storage unit 284 stores the programs executed by the processor 282, data used in the execution of the programs, and so on. Multiple storage units may be used as the storage unit 284.

The baseband processing circuit 286 may function as the synchronous detector-demodulator 202. The baseband processing circuit 286 processes a baseband signal.

The radio processing circuit 288 may function as the synchronous detector-demodulator 202. The radio processing circuit 288 processes a radio signal transmitted and received through the antenna 290.

The antenna 290 receives a signal transmitted from another apparatus.

The processing in the average calculator 204 and so on may be installed as a circuit, such as an application specific integrated circuit (ASIC) or a field programmable gate array (FPGA).

Although a turbo code having a coding rate of 1/3 is used as the encoding method here, another encoding method may be used. Each symbol in the 16QAM is an example of a symbol (multi-level modulation symbol). Although the 16QAM is used as the modulation scheme here, other multi-level modulation schemes including Quadrature Phase Shift Keying (QPSK), 64QAM, and 256QAM may be used as the modulation scheme.

### Exemplary Operation

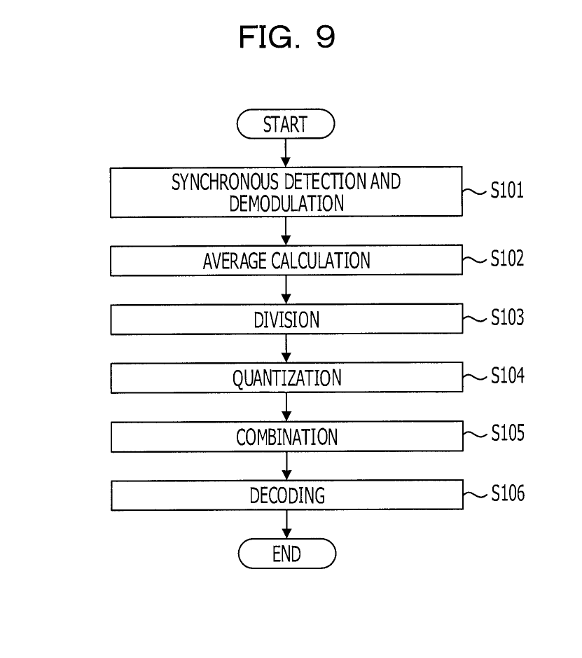

FIG. 9 is a flowchart illustrating an exemplary operational process performed by the reception apparatus of the first embodiment. The operational process in FIG. 9 is started, for example, upon reception of a signal by the reception apparatus 200.

Referring to FIG. 9, in Step S101, the synchronous detector-demodulator 202 performs the synchronous detection, the demodulation, and so on to a reception signal received through the antenna or the like. The reception symbol corresponding to the reception signal is acquired as a point on the IQ plane by the demodulation and so on. In addition, the synchronous detector-demodulator 202 calculates the likelihood (the soft decision data) of each bit in all the reception symbols. The bit precision of the soft decision data is, for example, 32 bits. The likelihood of each bit is calculated by, for example, X0−X1, as described above.

In Step S102, the average calculator 204 calculates the average of the absolute values of the likelihoods of the respective bits calculated by the synchronous detector-demodulator 202. The average calculator 204 calculates the average of the absolute values in certain units. The certain unit is, for example, the certain code length Nd (block) set in the transmission apparatus 100.

The average calculator 204 determines the average of the absolute values×a first certain number to be the maximum likelihood value of the bits in the first sub-block SB1. The average calculator 204 determines the average of the absolute values×a second certain number to be the maximum likelihood value of the bits in the second sub-block SB2. In other words, if the absolute value of the likelihood exceeds the maximum likelihood value, the absolute value of the likelihood is rounded to the maximum likelihood value in the quantization. The first certain number/the second certain number is a power of two (2ⁿ (n is an integer)). Provided that the average of the absolute values is denoted by A and the first certain number is denoted by B, the maximum likelihood value of the bits in the first sub-block SB1 is equal to A×B and the maximum likelihood value of the bits in the second sub-block SB2 is equal to A×B/2ⁿ. When the 16QAM is used as the modulation scheme, n may be set to one (n=1).

In Step S103, the divider 206 divides the likelihoods of the respective bits in each reception symbol into the first sub-block SB1 and the second sub-block SB2. The divider 206 supplies the first sub-block SB1 to the first quantizer 212 and supplies the second sub-block SB2 to the second quantizer 222. The first sub-block SB1 includes the zeroth bit and the first bit, among the bits in each reception symbol. The second sub-block SB2 includes the second bit and the third bit, among the bits in each reception symbol.

In Step S104, the first quantizer 212 and the second quantizer 222 each quantize the bit likelihood with the numbers of quantization bits. The processing in the first quantizer 212 may be performed in parallel with the processing in the second quantizer 222. Alternatively, the processing in the first quantizer 212 and the processing in the second quantizer 222 may be sequentially performed.

The first quantizer 212 quantizes the likelihood of each bit in the first sub-block SB1 calculated by the synchronous detector-demodulator 202 with the first number of quantization bits m. The first number of quantization bits m includes a sign bit. The sign bit represents positive or negative. Here, the likelihood of the bit exceeding the maximum value A×B is set to the maximum quantization value 2^{m-2}−1 with the first number of quantization bits m. The likelihood of the bit lower than a minimum value −A×B is set to the minimum quantization value −(2^{m-2}−1) with the first number of quantization bits m. If the likelihood of the bit is higher than or equal to −A×B and is lower than or equal to A×B, a value resulting from multiplication of the likelihood of the bit by 2^{m-2}/(A×B) is set as the value after the quantization. Fractions are, for example, truncated here. A value resulting from further division by 2^{m-2} may be set as the value after the quantization so that the value after the quantization is within a range from −1 to +1. The likelihoods of all the bits in the first sub-block SB1 is quantized with the first number of quantization bits m in the above manner. The likelihood of each bit may be quantized with the first number of quantization bits m by another method. The first quantizer 212 may quantize the likelihood of each bit with the first number of quantization bits m, for example, so that the minimum value after the quantization is equal to zero.

The first quantizer 212 stores the quantized data about the likelihood of each bit in the first sub-block SB1, which is quantized, in the first intermediate buffer 214.

The second quantizer 222 quantizes the likelihood of each bit in the second sub-block SB2 calculated by the synchronous detector-demodulator 202 with the second number of quantization bits m−n determined by the average calculator 204. The second number of quantization bits m−n includes the sign bit. Here, the likelihood of the bit exceeding the maximum value A×B/2ⁿ is set to the maximum quantization value 2^{m-n-2}−1 with the second number of quantization bits m−n. The likelihood of the bit lower than a minimum value −A×B/2ⁿ is set to the minimum quantization value −(2^{m-n-2}−1) with the second number of quantization bits m−n. If the likelihood of the bit is higher than or equal to −A×B/2ⁿ and is lower than or equal to A×B/2ⁿ, a value resulting from multiplication of the likelihood of the bit by 2^{m-n-2}/(A×B/2ⁿ) is set as the value after the quantization. Fractions are, for example, truncated here. A value resulting from further division by 2^{m-n-2} may be set as the value after the quantization so that the value after the quantization is within a range from −1 to +1. The likelihoods of all the bits in the second sub-block SB2 is quantized with the second number of quantization bits m−n in the above manner. The likelihood of each bit may be quantized with the second number of quantization bits m−n by another method. The second quantizer 222 may quantize the likelihood of each bit with the second number of quantization bits m−n, for example, so that the minimum value after the quantization is equal to zero.

The second quantizer 222 stores the quantized data about the likelihood of each bit in the second sub-block SB2, which is quantized, in the second intermediate buffer 224.

In Step S105, the combiner 232 reads out the likelihoods of the bits which are quantized from the first intermediate buffer 214 and the second intermediate buffer 224 and combines the likelihoods of the bits read out from the first intermediate buffer 214 with the likelihoods of the bits read out from the second intermediate buffer 224. Specifically, the combiner 232 reads out the likelihoods of the zeroth bit and the first bit from the first intermediate buffer 214 and reads out the likelihoods of the second bit and the third bit from the second intermediate buffer 224. The combiner 232 serially combines the likelihoods of the bits from the zeroth bit to the third bit, which have been read out, with each other for every reception symbol. The combiner 232 performs the bit adjustment in the combination so that the pieces of quantized data are represented in the same manner. The bit adjustment is performed by, for example, inserting zero into a low-order digit of the quantized data quantized with the smaller number of quantization bits so that the digit of the quantized data quantized with the smaller number of quantization bits is aligned with the digit of the quantized data quantized with the larger number of quantization bits.

In Step S106, the decoder 234 performs the error correction decoding by using the quantized data combined by the combiner 232 to estimate the transmission data.

Floating point quantization may be adopted as the quantization method. In the floating point quantization, the quantized data includes a sign part, an exponent part, and a mantissa part. When the floating point quantization is adopted, the number of quantization bits in the mantissa part is varied depending on the sub-block.

### Effects and Advantages of First Embodiment

The reception apparatus 200 of the first embodiment receives a 16QAM signal and performs the quantization with different numbers of quantization bits for different bits (for different sub-blocks) in the reception symbol. The reception apparatus 200 is capable of determining the number of quantization bits depending on the distribution of the likelihoods of the respective bits. With the reception apparatus 200, the determination of the number of quantization bits on the basis of the distribution of the likelihoods of the bits allows the capacities of the intermediate buffers in which the quantized data is stored to be reduced.

### Second Embodiment

A second embodiment will now be described. The configuration of the second embodiment has parts common to those in the configuration of the first embodiment. Accordingly, different points are mainly described and a description of the common parts is omitted herein.

Although the 16QAM is used as the modulation scheme in the first embodiment, the 64QAM is used as the modulation scheme in the second embodiment.

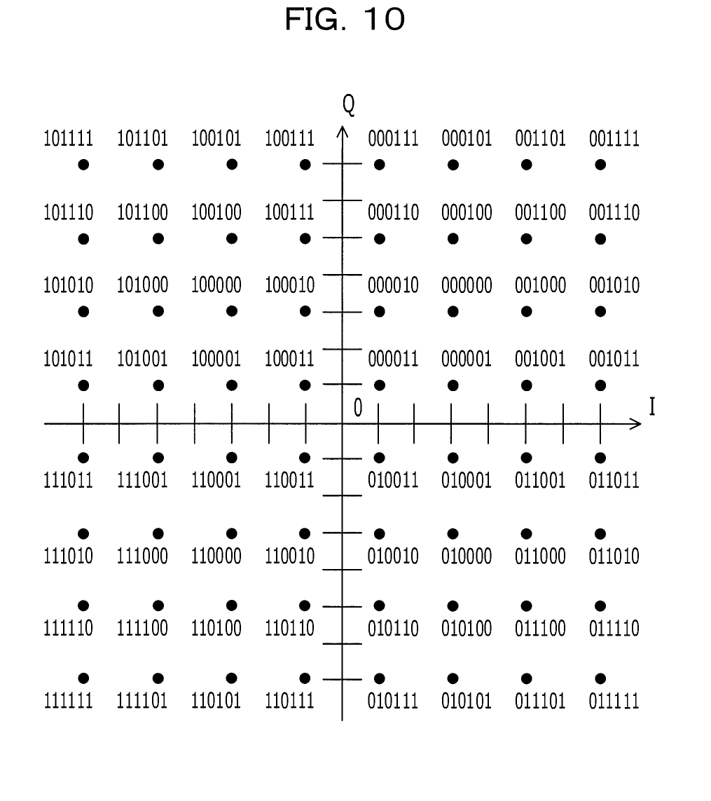

FIG. 10 illustrates an example of the 64QAM. Symbols in the 64QAM are represented by black circles in FIG. 10. A six-digit figure described near each symbol (black circle) is six-digit data allocated to the symbol. In the 64QAM, six-bit data is allocated each of 64-type combinations (symbols) of phase and amplitude. Here, the respective bits of the six-bit data represented by one symbol are called a zeroth bit, a first bit, a second bit, a third bit, a fourth bit, and a fifth bit, from the left side.

In the 64QAM illustrated in, for example, FIG. 10, since the arrangement of “0” and “1” on the IQ plane of the zeroth bit is the same as the arrangement of “0” and “1” on the IQ plane of the first bit, the distribution of the likelihoods of the zeroth bit is similar to that of the first bit. Similarly, since the arrangement of “0” and “1” on the IQ plane of the second bit is the same as the arrangement of “0” and “1” on the IQ plane of the third bit, the distribution of the likelihoods of the second bit is similar to that of the third bit. Since the arrangement of “0” and “1” on the IQ plane of the fourth bit is the same as the arrangement of “0” and “1” on the IQ plane of the fifth bit, the distribution of the likelihoods of the fourth bit is similar to that of the fifth bit. In contrast, since the arrangements of “0” and “1” on the IQ plane of the zeroth bit, the second bit, and the fourth bit are different from each other, the distributions of the likelihoods of the zeroth bit, the second bit, and the fourth bit are different from each other. Similarly, since the arrangements of “0” and “1” on the IQ plane of the first bit, the third bit, and the fifth bit are different from each other, the distributions of the likelihoods of the first bit, the third bit, and the fifth bit are different from each other. Three types of distributions of the likelihoods of the bits are assumed in the 64QAM.

The distribution of the likelihoods depends on the arrangement of the symbols the bit of which have a value of “0” and the arrangement of the symbols the bit of which have a value of “1”. In the example in FIG. 10, the distribution of the likelihoods of the fourth bit is wider than the distribution of the likelihoods of the second bit, and the distribution of the likelihoods of the second bit is wider than the distribution of the likelihoods of the zeroth bit. In other words, the dynamic range of the distribution of the likelihoods of the zeroth bit is wider than the dynamic range of the distribution of the likelihoods of the second bit and the dynamic range of the distribution of the likelihoods of the fourth bit. When the dynamic range of the distribution of the likelihoods is narrow, the numbers of quantization bits of the likelihoods may be small.

### Exemplary Configuration

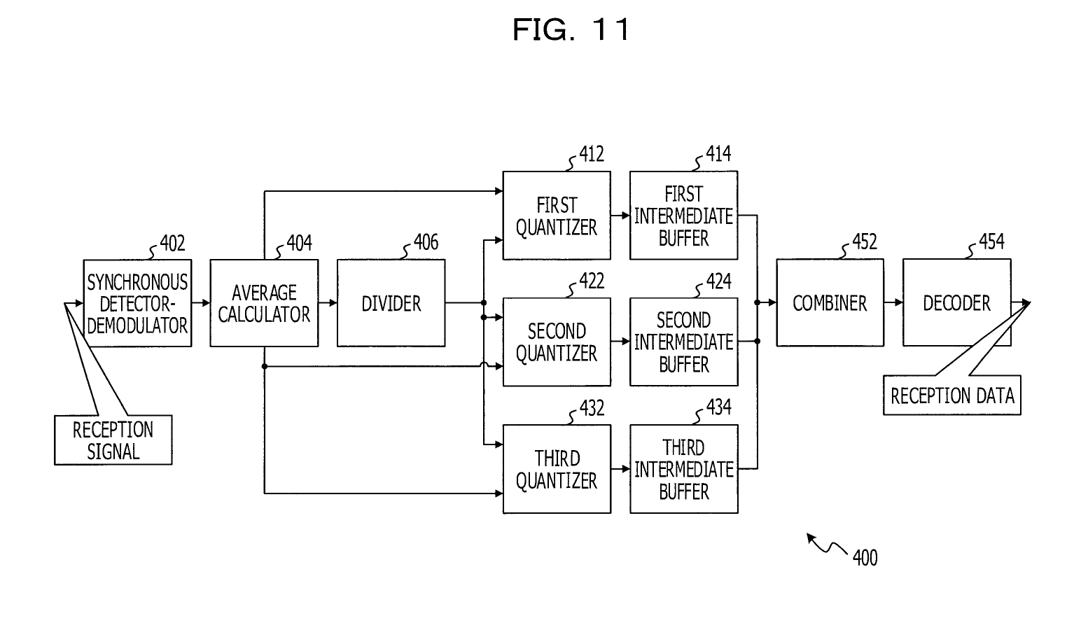

FIG. 11 illustrates an example of a reception apparatus of the second embodiment. Referring to FIG. 11, a reception apparatus 400 includes a synchronous detector-demodulator 402, an average calculator 404, and a divider 406. The reception apparatus 400 also includes a first quantizer 412, a first intermediate buffer 414, a second quantizer 422, a second intermediate buffer 424, a third quantizer 432, a third intermediate buffer 434, a combiner 452, and a decoder 454.

The synchronous detector-demodulator 402 performs, for example, the synchronous detection to a reception signal received through the antenna or the like to acquire the reception symbol as a point on the IQ plane. The signal received here is the signal modulated in the 64QAM in the transmission apparatus. The synchronous detector-demodulator 402 calculates the likelihood (soft decision data) of each bit in the reception symbol. The bit precision of the soft decision data is, for example, 32 bits.

The average calculator 404 calculates the average of the absolute values of the likelihoods of the respective bits calculated by the synchronous detector-demodulator 402. The average calculator 404 calculates the average of the absolute values in certain units. One reception symbol is divided into the first sub-block SB1 including the zeroth bit and the first bit, the second sub-block SB2 including the second bit and the third bit, and a third sub-block SB3 including the fourth bit and the fifth bit.

The average calculator 404 determines the average of the absolute values×a first certain number to be the maximum likelihood value of the bits in the first sub-block SB1. The average calculator 404 determines the average of the absolute values×a second certain number to be the maximum likelihood value of the bits in the second sub-block SB2. The average calculator 404 determines the average of the absolute values×a third certain number to be the maximum likelihood value of the bits in the third sub-block SB3. The first certain number/the second certain number is a power of two (2ⁿ (n is an integer)). The first certain number/the third certain number is a power of two (2^{p} (p is an integer)). Provided that the average of the absolute values is denoted by A and the first certain number is denoted by B, the maximum likelihood value of the bits in the first sub-block SB1 is equal to A×B, the maximum likelihood value of the bits in the second sub-block SB2 is equal to A×B/2ⁿ, and the maximum likelihood value of the bits in the third sub-block SB3 is equal to A×B/2^{p}. For example, n is equal to one (n=1) and p is equal to two (p=2) here.

The maximum likelihood value of the bits in the first sub-block SB1, the maximum likelihood value of the bits in the second sub-block SB2, and the maximum likelihood value of the bits in the third sub-block SB3 determined by the average calculator 404 are supplied to the first quantizer 412, the second quantizer 422, and the third quantizer 432, respectively.

The number of quantization bits of the likelihood of each bit in the first sub-block SB1 is denoted by m. The number of quantization bits of the likelihood of each bit in the second sub-block SB2 is denoted by m−n. The number of quantization bits of the likelihood of each bit in the third sub-block SB3 is denoted by m−p. The above-mentioned m, n, and p are determined in advance on the basis of, for example, the sizes of the intermediate buffers and are stored in the storage unit or the like. The above-mentioned m, n, and p may be determined on the basis of the distribution of the likelihoods of the bits.

The combiner 452 reads out the likelihoods of the bits, which are quantized, from the first intermediate buffer 414, the second intermediate buffer 424, and the third intermediate buffer 434 and combines the likelihoods of the bits with each other. Specifically, the combiner 452 reads out the likelihood of the zeroth bit and the likelihood of the first bit from the first intermediate buffer 414, reads out the likelihood of the second bit and the likelihood of the third bit from the second intermediate buffer 424, and reads out the likelihood of the fourth bit and the likelihood of the fifth bit from the third intermediate buffer 434. The combiner 452 serially combines the likelihoods of the bits from the zeroth bit to the fifth bit, which have been read out, with each other for every reception symbol. The combiner 452 performs the bit adjustment in the combination so that the pieces of quantized data are represented in the same manner. The bit adjustment is performed by, for example, inserting zero into a low-order digit of the quantized data quantized with the smaller number of quantization bits so that the digit of the quantized data quantized with the smaller number of quantization bits is aligned with the digit of the quantized data quantized with the larger number of quantization bits.

The reception apparatus 400 operates in the same manner as in the exemplary operational process in FIG. 9.

### Effects and Advantages of Second Embodiment

The reception apparatus 400 of the second embodiment receives a 64QAM signal and performs the quantization with different numbers of quantization bits for different bits in the reception symbol. The reception apparatus 400 is capable of determining the numbers of quantization bits depending on the distribution of the likelihoods of the respective bits.

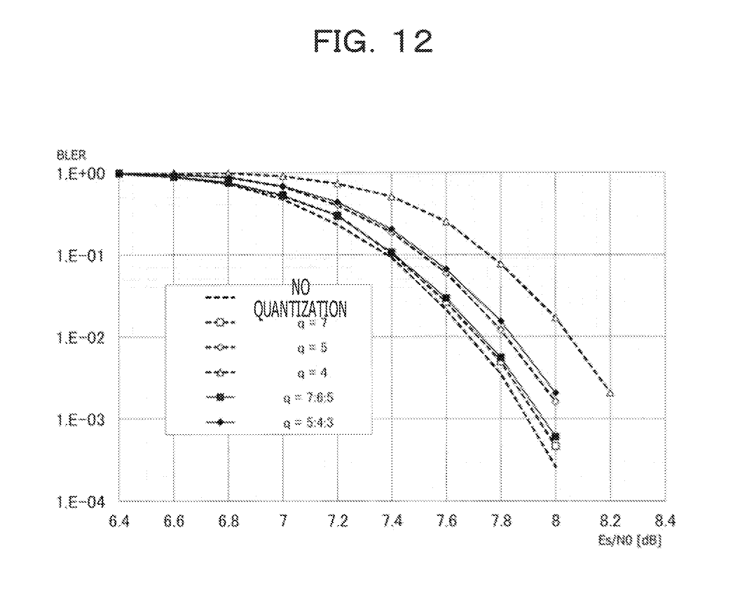

FIG. 12 illustrates an example of block error rates (BLERs) when the number of quantization bits is varied. In a graph in FIG. 12, the horizontal axis represents signal to noise power ratio and the vertical axis represents logarithmic expression of the BLER. The precision is improved with the decreasing BLER in the graph in FIG. 12.

The graph in FIG. 12 illustrates an example in which no quantization is performed, examples in which all the bits are quantized with the same number of quantization bits, and examples in which different bits are quantized with different numbers of quantization bits. The examples in which all the bits are quantized with the same number of quantization bits include an example in which the number of quantization bits is equal to seven (q=7), an example in which the number of quantization bits is equal to five (q=5), and an example in which the number of quantization bits is equal to four (q=4). The examples in which different bits are quantized with different numbers of quantization bits include an example in which the first number of quantization bits, the second number of quantization bits, and the third number of quantization bits are set to seven, six, and five, respectively, (q=7:6:5) and an example in which the first number of quantization bits, the second number of quantization bits, and the third number of quantization bits are set to five, four, and three, respectively, (q=5:4:3). The size of the intermediate buffer when the numbers of quantization bits are set to seven, six, and five (q=7:6:5) is equal to the size of the intermediate buffer when the number of quantization bits is set to six for all the bits. The size of the intermediate buffer when the numbers of quantization bits are set to five, four, and three (q=5:4:3) is equal to the size of the intermediate buffer when the number of quantization bits is set to four for all the bits. The example in which the numbers of quantization bits are set to seven, six, and five (q=7:6:5) and the example in which the numbers of quantization bits are set to five, four, and three (q=5:4:3) are realized by the reception apparatus 400 of the second embodiment.

Referring to FIG. 12, the BLER in the example in which the numbers of quantization bits are set to seven, six, and five (q=7:6:5) is the same as the BLER in the example in which the number of quantization bits is set to seven for all the bits.

In addition, the BLER in the example in which the numbers of quantization bits are set to five, four, and three (q=5:4:3) is the same as the BLER in the example in which the number of quantization bits is set to five for all the bits. Furthermore, the BLER in the example in which the numbers of quantization bits are set to five, four, and three (q=5:4:3) is lower than the BLER in the example in which the number of quantization bits is set to four for all the bits.

Accordingly, the size of the intermediate buffer when the numbers of quantization bits are se t to seven, six, and five (q=7:6:5) is similar to that of the intermediate buffer when the number of quantization bits is set to six for all the bits, and the BLER in the example in which the numbers of quantization bits are set to seven, six, and five (q=7:6:5) is the same as the BLER in the example in which the number of quantization bits is set to seven for all the bits. In other words, with the reception apparatus 400, it is possible to realize the decoding at higher precision with the smaller intermediate buffers.

### Third Embodiment

A third embodiment will now be described. The configuration of the third embodiment has parts common to the configurations of the first embodiment and the second embodiment. Accordingly, different points are mainly described and a description of the common parts is omitted herein.

The third embodiment differs from the first embodiment and the second embodiment in the average calculator in the reception apparatus. In the third embodiment, no average calculator exists in the reception apparatus. The processing corresponding to the processing in the average calculator is performed in the divider in the third embodiment. Specifically, the average calculation is performed after the division in the third embodiment. Although the 16QAM in the first embodiment is exemplarily described in the third embodiment, the same applies to the 64QAM in the second embodiment.

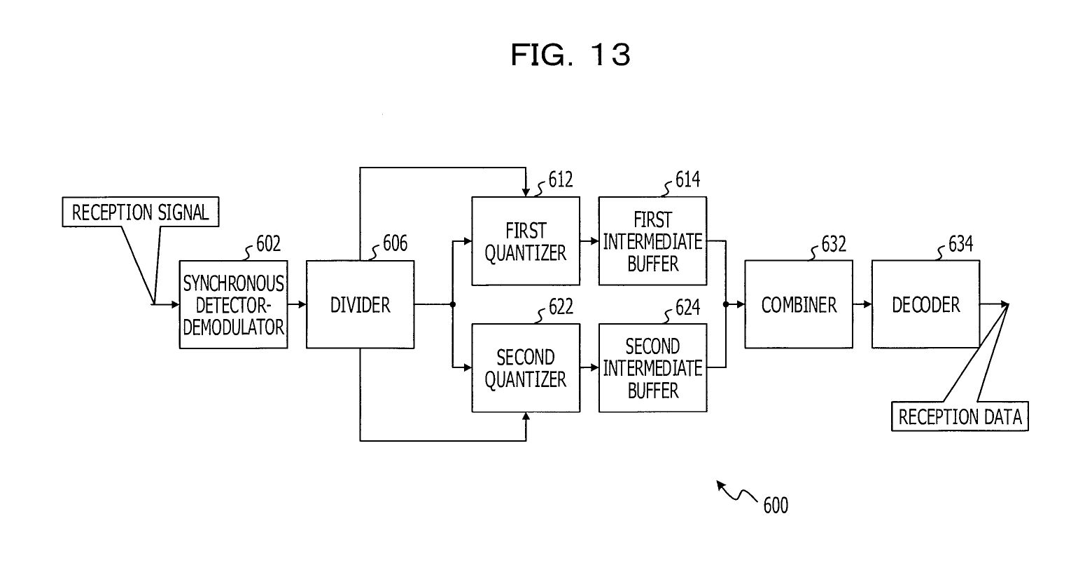

FIG. 13 illustrates an example of a reception apparatus of the third embodiment. Referring to FIG. 13, a reception apparatus 600 includes a synchronous detector-demodulator 602, a divider 606, a first quantizer 612, a first intermediate buffer 614, a second quantizer 622, a second intermediate buffer 624, a combiner 632, and a decoder 634.

In the reception apparatus 600 in the third embodiment, the average calculating process is performed in the divider 606. The divider 606 divides the likelihoods of the respective bits in each reception symbol into the first sub-block SB1 and the second sub-block SB2. The divider 606 calculates the average of the absolute values of the likelihoods of the respective bits for every sub-block resulting from the division and in certain units. The average of the absolute values of the likelihoods of the bits in the first sub-block SB1 is denoted by A1 and the average of the absolute values of the likelihoods of the bits in the second sub-block SB2 is denoted by A2.

The divider 606 determines the average of the absolute values A1×a first certain number to be the maximum likelihood value of the bits in the first sub-block SB1. The divider 606 determines the average of the absolute values A2×a second certain number to be the maximum likelihood value of the bits in the second sub-block SB2. For example, t, the first certain number, and the second certain number are determined so that (A1×the first certain number)/(A2×the second certain number)=2^{t} (t is an integer).

The divider 606 may determine t in the following manner. Specifically, the divider 606 may determine the absolute values A1×a certain number to be the maximum likelihood value of the bits in the first sub-block SB1 and may determine the absolute values A1/2^{t}×the certain number to be the maximum likelihood value of the bits in the second sub-block SB2. Here, t is a minimum value meeting an inequality A2≦A1/2^{t} (t is an integer). The certain number is commonly used and is determined in advance.

The divider 606 supplies the maximum likelihood value of the bits in the first sub-block SB1 to the first quantizer 612 and supplies the maximum likelihood value of the bits in the second sub-block SB2 to the second quantizer 622. The divider 606 supplies the first sub-block SB1 to the first quantizer 612 and supplies the second sub-block SB2 to the second quantizer 622.

The number of quantization bits of the likelihood of each bit in the first sub-block SB1 is denoted by m and the number of quantization bits of the likelihood of each bit in the second sub-block SB2 is denoted by m−t. When t is equal to a positive number, the second intermediate buffer 624 may be made smaller than the first intermediate buffer 614.

The number of quantization bits m of the likelihood of each bit in the first sub-block SB1 is determined in advance on the basis of, for example, the size of the intermediate buffer and is stored in the storage unit or the like. The number of quantization bits m may be determined on the basis of the distribution of the likelihoods of the bits.

### Effects and Advantages of Third Embodiment

With the reception apparatus 600 of the third embodiment, the use of the average of the absolute values of the likelihoods of the bits in each sub-block allows the number of quantization bits matched with the distribution of the likelihoods of the bits in each sub-block to be determined. The use of the number of quantization bits matched with the distribution of the likelihoods of the bits allows the intermediate buffers to have more appropriate sizes. Since the number of quantization bits of the bits in each sub-block is determined on the basis of the average of the absolute values of the likelihoods of the bits in each sub-block, it is possible to suppress a variation in the decoding precision of the bits between the sub-blocks.

### Fourth Embodiment

A fourth embodiment will now be described. The configuration of the fourth embodiment has parts common to the configurations of the first embodiment, the second embodiment, and the third embodiment. Accordingly, different points are mainly described and a description of the common parts is omitted herein.

A reception apparatus of the fourth embodiment mainly differs from those of the first embodiment, the second embodiment, and the third embodiment in that the coding rate is supplied to each quantizer from a control information processor. Although the 64QAM in the second embodiment is exemplarily described in the fourth embodiment, the same applies to the 16QAM in the first embodiment.

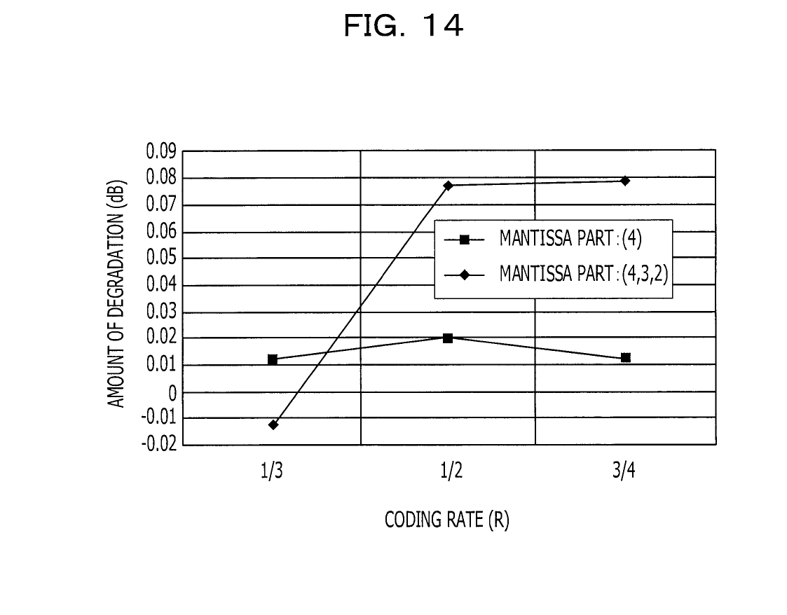

FIG. 14 is a graph illustrating the relationship between the coding rate and the amount of signal degradation. The floating point quantization is adopted as the quantization method in FIG. 14. In the floating point quantization, the quantized data includes a sign part, an exponent part, and a mantissa part. In FIG. 14, an example (mantissa part: (4)) in which the number of quantization bits in the mantissa part is fixed is compared with an example (mantissa part: (4:3:2)) in which the number of quantization bits in the mantissa part is varied depending on the sub-block, as in the reception apparatus 400 of the second embodiment. The former example is denoted by B1 and the latter example is denoted by B2. The numbers of bits in the sign part and the exponent part in the example B1 are the same as those in the example B2. The number of bits in the mantissa part is four bits in the example B1 while the number of bits in the mantissa part is four bits in the first sub-block SB1, three bits in the second sub-block SB2, and two bits in the third sub-block SB3 in the example B2. In the comparison at a coding rate of 1/3, the amount of signal degradation in the example B1 is greater than that in the example B2. In contrast, in the comparison at a coding rate of 1/2 or 3/4, the amount of signal degradation in the example B2 is greater than that in the example B1. Accordingly, when the coding rate is higher than 1/3, it is not desirable to vary the number of quantization bits in the mantissa part depending on the sub-block, as in the reception apparatus 400 of the second embodiment.

The reception apparatus of the fourth embodiment receives a control signal including the coding rate of a reception signal from a higher-level apparatus, a transmission apparatus, or the like. The reception apparatus of the fourth embodiment varies the number of quantization bits depending on the coding rate of the reception signal.

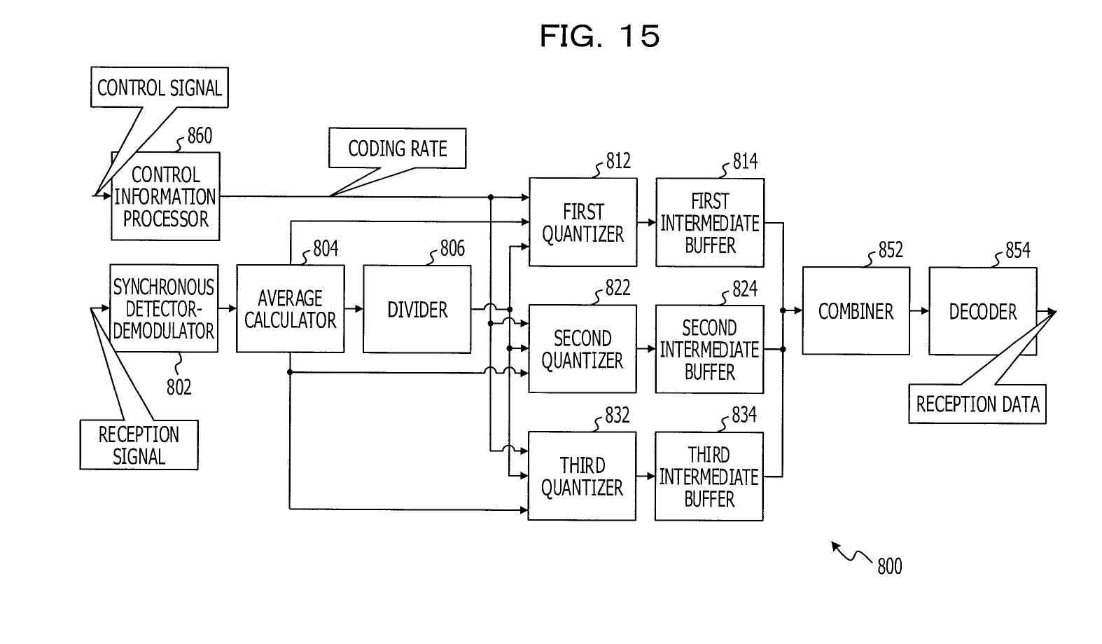

FIG. 15 illustrates an example of the reception apparatus of the fourth embodiment. Referring to FIG. 15, a reception apparatus 800 has substantially the same configuration as that of the reception apparatus 400 of the second embodiment. The reception apparatus 800 includes a synchronous detector-demodulator 802, an average calculator 804, and a divider 806. The reception apparatus 800 also includes a first quantizer 812, a first intermediate buffer 814, a second quantizer 822, a second intermediate buffer 824, a third quantizer 832, a third intermediate buffer 834, a combiner 852, a decoder 854, and a control information processor 860.

The control information processor 860 receives the control signal including the coding rate of the reception signal from a higher-level apparatus, a transmission apparatus, or the like. The control information processor 860 extracts information about the coding rate of the reception signal from the received control information. The control information processor 860 supplies the extracted information about the coding rate to the first quantizer 812, the second quantizer 822, and the third quantizer 832.

As in the example of the second embodiment, the number of quantization bits of the likelihood of each bit in the first sub-block SB1 is denoted by m, the number of quantization bits of the likelihood of each bit in the second sub-block SB2 is denoted by m−n, and the number of quantization bits of the likelihood of each bit in the third sub-block SB3 is denoted by m−p.

The first quantizer 812 receives the information about the coding rate of the reception signal from the control information processor 860. The first quantizer 812 quantizes the likelihood of each bit in the first sub-block Sb 1 calculated by the synchronous detector-demodulator 802 with the first number of quantization bits m, regardless of whether the coding rate is lower than or equal to 1/3 or higher than 1/3. The first number of quantization bits m includes the sign bit. Here, the likelihood of the bit exceeding the maximum value A×B is set to the maximum quantization value 2^{m-2}−1 with the first number of quantization bits m. The likelihood of the bit lower than the minimum value −A×B is set to the minimum quantization value −(2^{m-2}−1) with the first number of quantization bits m. If the likelihood of the bit is higher than or equal to −A×B and is lower than or equal to A×B, a value resulting from multiplication of the likelihood of the bit by 2^{m-2}/(A×B) is set as the value after the quantization. Fractions are, for example, truncated here. A value resulting from further division by 2^{m-2} may be set as the value after the quantization so that the value after the quantization is within a range from −1 to +1. The likelihoods of all the bits in the first sub-block SB1 is quantized with the first number of quantization bits m in the above manner. The likelihood of each bit may be quantized with the first number of quantization bits m by another method. The first quantizer 812 may quantize the likelihood of each bit with the first number of quantization bits m, for example, so that the minimum value after the quantization is equal to zero.

The second quantizer 822 receives the information about the coding rate of the reception signal from the control information processor 860. The second quantizer 822 quantizes the likelihood of each bit in the second sub-block SB2 calculated by the synchronous detector-demodulator 802 with the first number of quantization bits m if the coding rate is lower than or equal to 1/3, as in the first quantizer 812. The second quantizer 822 quantizes the likelihood of each bit in the second sub-block SB2 calculated by the synchronous detector-demodulator 802 with the second number of quantization bits m−n determined by the average calculator 804 if the coding rate is higher than 1/3. The second number of quantization bits m−n includes the sign bit. Here, the likelihood of the bit exceeding the maximum value A×B/2ⁿ is set to the maximum quantization value 2^{m-n-2}−1 with the second number of quantization bits m−n. The likelihood of the bit lower than the minimum value −A×B/2ⁿ is set to the minimum quantization value −(2^{m-n-2}−1) with the second number of quantization bits m−n. If the likelihood of the bit is higher than or equal to −A×B/2ⁿ and is lower than or equal to A×B/2ⁿ, a value resulting from multiplication of the likelihood of the bit by 2^{m-n-2}/(A×B/2ⁿ) is set as the value after the quantization. Fractions are, for example, truncated here. A value resulting from further division by 2^{m-n-2} may be set as the value after the quantization so that the value after the quantization is within a range from −1 to +1. The likelihoods of all the bits in the second sub-block SB2 is quantized with the second number of quantization bits m−n in the above manner. The likelihood of each bit may be quantized with the second number of quantization bits m−n by another method. The second quantizer 822 may quantize the likelihood of each bit with the second number of quantization bits m−n, for example, so that the minimum value after the quantization is equal to zero.

The third quantizer 832 has the same configuration as that of the second quantizer 822. Specifically, the third quantizer 832 receives the information about the coding rate of the reception signal from the control information processor 860. The third quantizer 832 quantizes the likelihood of each bit in the third sub-block SB3 calculated by the synchronous detector-demodulator 802 with the first number of quantization bits m if the coding rate is lower than or equal to 1/3, as in the first quantizer 812. The third quantizer 832 quantizes the likelihood of each bit in the third sub-block SB3 calculated by the synchronous detector-demodulator 802 with the third number of quantization bits m−p determined by the average calculator 804 if the coding rate is higher than 1/3.

### Effects and Advantages of Fourth Embodiment

The control information processor 860 in the reception apparatus 800 supplies the information about the coding rate to each quantizer. Each quantizer varies the number of quantization bits depending on the coding rate. Specifically, if the coding rate of the reception signal is lower than or equal to 1/3, the reception apparatus 800 sets the number of quantization bits of the likelihood of each bit to the number of quantization bits, which depends on the sub-block. If the coding rate of the reception signal is higher than 1/3, the reception apparatus 800 sets the number of quantization bits of the likelihood of each bit to a fixed number of quantization bits, which does not depend on the sub-block.

With the reception apparatus 800, it is possible to vary the number of quantization bits depending on the coding rate of the reception signal to realize the decoding with the smaller amount of signal degradation.

### Fifth Embodiment

A fifth embodiment will now be described. The configuration of the fifth embodiment has parts common to the configurations of the first embodiment, the second embodiment, the third embodiment, and the fourth embodiment. Accordingly, different points are mainly described and a description of the common parts is omitted herein.

In a system of the fifth embodiment, hybrid automatic repeat request (H-ARQ) is adopted. Although the 16QAM in the first embodiment is exemplarily described in the fifth embodiment, the same applies to the 64QAM in the second embodiment.

The H-ARQ is an encoding system in which automatic repeat request (ARQ) is combined with the error correction coding.

### Exemplary Configuration

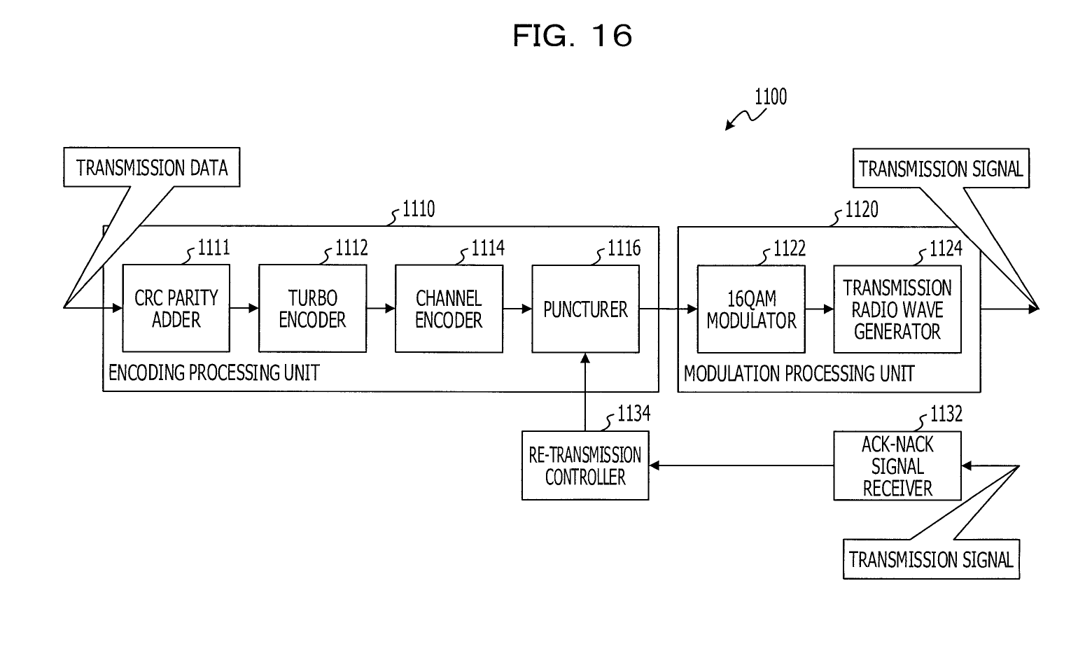

FIG. 16 illustrates an example of a transmission apparatus of the fifth embodiment. Referring to FIG. 16, a transmission apparatus 1100 includes an encoding processing unit 1110, a modulation processing unit 1120, an ACK-NACK signal receiver 1132, and a re-transmission controller 1134. The encoding processing unit 1110 includes a CRC parity adder 1111, a turbo encoder 1112, a channel encoder 1114, and a puncturer 1116. The modulation processing unit 1120 includes a 16QAM modulator 1122 and a transmission radio wave generator 1124.

The CRC parity adder 1111 in the encoding processing unit 1110 adds a cyclic redundancy check (CRC) parity to data to be transmitted (transmission data) as an error detection code.

The turbo encoder 1112 performs the turbo encoding to the output from the CRC parity adder 1111. The output from the CRC parity adder 1111 may be divided into multiple packets to be subjected to the turbo encoding. Provided that the output from the CRC parity adder 1111 (or one packet) has a size of K bits, the encoded bit size Nt=3×K+12 bits.

The channel encoder 1114 performs the rate matching so that the data subjected to the turbo encoding has a certain code length. Provided that the certain code length is denoted by Nd, a coding rate R=K/Nd. The data having the certain code length is also called a block. The channel encoder 1114 performs the interleaving in which the order of bit sequences is changed in a certain pattern before or after the rate matching.

The puncturer 1116 performs puncturing of an encoded bit sequence. The puncturing means that some bits in the encoded bit sequence are decimated according to a certain rule. The decimation reduces the size of the bit sequence to be transmitted. The puncturer 1116 stores the encoded bit sequence before the decimation in the storage unit. Upon reception of a re-transmission instruction from the re-transmission controller 1134, the puncturer 1116 decimates some bits in the encoded bit sequence to which the re-transmission instruction is issued according to the certain rule. Upon reception of a deletion instruction from the re-transmission controller 1134, the puncturer 1116 deletes the encoded bit sequence to which the deletion instruction is issued from the storage unit. The puncturer 1116 may be included in the channel encoder 1114.

The 16QAM modulator 1122 in the modulation processing unit 1120 performs the 16QAM modulation to the output from encoding processing unit 1110. The 16QAM modulator 1122 converts a signal that is input into one symbol for every four bits. As in the example in FIG. 1, the zeroth bit and the second bit are mapped as the I components and the first bit and the third bit are mapped as the Q components.

The transmission radio wave generator 1124 in the modulation processing unit 1120 converts the output from 16QAM modulator 1122 into a certain radio frequency and transmits the signal of the certain radio frequency to a reception apparatus 1200 through the antenna or the like.

The ACK-NACK signal receiver 1132 receives an acknowledgement (ACK) signal or a negative acknowledgement (NACK) signal from the reception apparatus 1200. The ACK signal indicates that a signal transmitted from the transmission apparatus 1100 has been decoded by the reception apparatus 1200. The NACK signal indicates that a signal transmitted from the transmission apparatus 1100 has not been decoded by the reception apparatus 1200. The ACK-NACK signal receiver 1132 supplies the ACK signal or the NACK signal that is received to the re-transmission controller 1134.

The re-transmission controller 1134 receives the ACK signal or the NACK signal from the ACK-NACK signal receiver 1132. The re-transmission controller 1134 instructs the puncturer 1116 to delete the encoded bit sequence corresponding to the ACK signal upon reception of the ACK signal. The re-transmission controller 1134 instructs the puncturer 1116 to re-transmit the encoded bit sequence corresponding to the NACK signal upon reception of the NACK signal.

A combination of bits, which is the same as that in the bit sequence that has been first transmitted, is selected in the re-transmission. This is called a chase combining (CC) scheme.

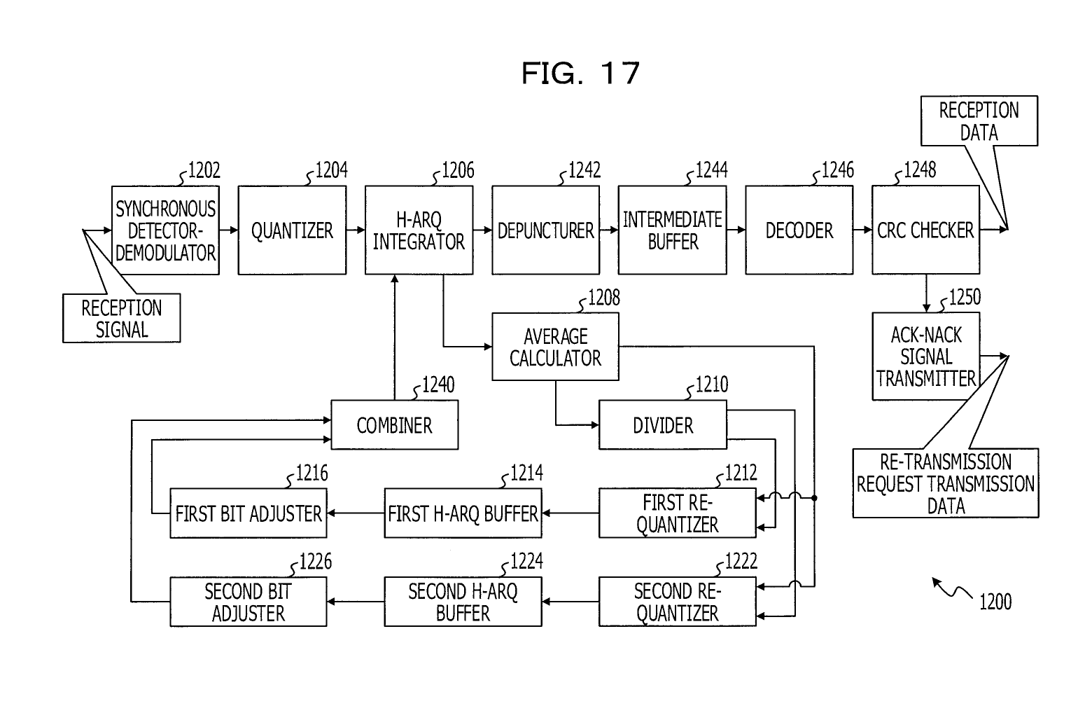

FIG. 17 illustrates an example of the reception apparatus of the fifth embodiment. Referring to FIG. 17, the reception apparatus 1200 includes a synchronous detector-demodulator 1202, a quantizer 1204, an H-ARQ integrator 1206, an average calculator 1208, and a divider 1210. The reception apparatus 1200 also includes a first re-quantizer 1212, a first H-ARQ buffer 1214, a first bit adjuster 1216, a second re-quantizer 1222, a second H-ARQ buffer 1224, a second bit adjuster 1226, and a combiner 1240. The reception apparatus 1200 further includes a depuncturer 1242, an intermediate buffer 1244, a decoder 1246, a CRC checker 1248, and an ACK-NACK signal transmitter 1250.

The synchronous detector-demodulator 1202 performs, for example, the synchronous detection to a reception signal received through the antenna or the like to acquire the reception symbol as a point on the IQ plane. The synchronous detector-demodulator 1202 calculates the likelihood (soft decision data) of each bit in the reception symbol.

The quantizer 1204 quantizes the likelihood of each bit in the reception symbol with a certain number of quantization bits. In the fifth embodiment, the quantizer 1204 quantizes all the bits with the same number of quantization bits. The quantizer 1204 may quantize different bits with different numbers of quantization bits, for example, as in the reception apparatus 200 of the first embodiment.

The H-ARQ integrator 1206 determines whether data supplied from the quantizer 1204 is re-transmission data.

If the data supplied from the quantizer 1204 is not the re-reception data, the H-ARQ integrator 1206 directly supplies the data supplied from the quantizer 1204 to the depuncturer 1242.

If the data supplied from the quantizer 1204 is the re-reception data, the H-ARQ integrator 1206 reads out pieces of data corresponding to the data supplied from the quantizer 1204 from the first H-ARQ buffer 1214 and the second H-ARQ buffer 1224. The pieces of data which are read out are subjected to the bit adjustment in the first bit adjuster 1216 and the second bit adjuster 1226. The pieces of data which are subjected to the bit adjustment are combined with each other in the combiner 1240. The H-ARQ integrator 1206 receives the pieces of data which are combined from the combiner 1240. The H-ARQ integrator 1206 integrates the data supplied from the quantizer 1204 with the data supplied from the combiner 1240. The H-ARQ integrator 1206 supplies the integrated data to the depuncturer 1242. Since the re-transmission method is the CC scheme, the same transmission bit is mapped to the same bit position in modulation mapping.

The H-ARQ integrator 1206 also supplies the data to be supplied to the depuncturer 1242 to the average calculator 1208.

The same data as the data (symbol) to be supplied to the depuncturer 1242 is input into the average calculator 1208. The average calculator 1208 calculates the average of the absolute values of the likelihoods of the respective bits in the symbol that is input. The average calculator 1208 calculates the average of the absolute values in certain units. The certain unit is, for example, the certain code length Nd (block) set in the transmission apparatus 1100. One symbol is divided into the first sub-block SB1 including the zeroth bit and the first bit and the second sub-block SB2 including the second bit and the third bit.

The average calculator 1208 determines a first certain multiple of the average of the absolute values (the average of the absolute values×a first certain number) to be the maximum likelihood value of the bits in the first sub-block SB1. The average calculator 1208 determines a second certain multiple of the average of the absolute values (the average of the absolute values×a second certain number) to be the maximum likelihood value of the bits in the second sub-block SB2. The first certain number/the second certain number is a power of two (2ⁿ (n is an integer)). Provided that the average of the absolute values is denoted by A and the first certain number is denoted by B, the maximum likelihood value of the bits in the first sub-block SB1 is equal to A×B and the maximum likelihood value of the bits in the second sub-block SB2 is equal to A×B/2ⁿ.

The maximum likelihood value of the bits in the first sub-block SB1 and the maximum likelihood value of the bits in the second sub-block SB2 determined by the average calculator 1208 are supplied to the first re-quantizer 1212 and the second re-quantizer 1222, respectively.

The average calculator 1208 may determine the maximum likelihood, among the likelihoods of the bits in the first sub-block SB1, to be the maximum likelihood value of the bits in the first sub-block SB1. The average calculator 1208 may determine the maximum likelihood, among the likelihoods of the bits in the second sub-block SB2, to be the maximum likelihood value of the bits in the second sub-block SB2. The maximum likelihood value of the bits in each sub-block may be determined on the basis of the distribution of the likelihoods of the bits in each sub-block.

The divider 1210 divides the likelihoods of the respective bits in each symbol into the first sub-block SB1 and the second sub-block SB2. The divider 1210 supplies the first sub-block SB1 to the first re-quantizer 1212. The divider 1210 supplies the second sub-block SB2 to the second re-quantizer 1222.

The first re-quantizer 1212 quantizes the likelihood of each bit in the first sub-block SB1 with the first number of quantization bits m.

The first H-ARQ buffer 1214 stores the quantized data about the likelihood of each bit in the first sub-block SB1 quantized by the first re-quantizer 1212. The data stored in the first H-ARQ buffer 1214 is read out by the first bit adjuster 1216 in response to an instruction from the H-ARQ integrator 1206.

The first bit adjuster 1216 reads out the likelihood of the zeroth bit and the likelihood of the first bit stored in the first H-ARQ buffer 1214 to perform the bit adjustment. The bit adjustment is performed by, for example, inserting zero into a low-order digit of the data that is read out so that the digit is aligned with the digit of the quantized data in the quantizer 1204.

The second re-quantizer 1222 quantizes the likelihood of each bit in the second sub-block SB2 with the second number of quantization bits m−n in the same manner as in the first re-quantizer 1212.

The above-mentioned m and n are determined in advance on the basis of, for example, the sizes of the H-ARQ buffers and are stored in the storage unit or the like. The above-mentioned m and n may be determined on the basis of the distribution of the likelihoods of the bits. When the distribution of the likelihoods of the bits is narrow, high-order bits in the quantized data are often not used. Accordingly, making the numbers of quantization bits small allows the sizes of the H-ARQ buffers to be decreased. When n is not equal to zero, the first number of quantization bits is different from the second number of quantization bits.

The second H-ARQ buffer 1224 stores the quantized data about the likelihood of each bit in the second sub-block SB2 quantized by the second re-quantizer 1222. When n is not equal to zero, the size of the first H-ARQ buffer 1214 is different from the size of the second H-ARQ buffer 1224. When n is equal to a positive number, the size of the second H-ARQ buffer 1224 is smaller than the size of the first H-ARQ buffer 1214. In other words, the size of the second H-ARQ buffer 1224 may be equal to (m−n)/m multiple of the size of the first H-ARQ buffer 1214. The number of the likelihoods of the bits stored in the first H-ARQ buffer 1214 is the same as that in the second H-ARQ buffer 1224. The data stored in the second H-ARQ buffer 1224 is read out by the second bit adjuster 1226 in response to an instruction from the H-ARQ integrator 1206.

The second bit adjuster 1226 reads out the likelihood of the second bit and the likelihood of the third bit stored in the second H-ARQ buffer 1224 to perform the bit adjustment. The bit adjustment is performed by, for example, inserting zero into a low-order digit of the data that is read out so that the digit is aligned with the digit of the quantized data in the quantizer 1204.

The combiner 1240 serially combines the likelihood of the zeroth bit and the likelihood of the first bit subjected to the bit adjustment in the first bit adjuster 1216 with the likelihood of the second bit and the likelihood of the third bit subjected to the bit adjustment in the second bit adjuster 1226.

The depuncturer 1242 performs depuncturing, which is inverse processing of the puncturing, to the data that is input. The depuncturing means that a certain value is inserted to the position of the bit that is subjected to the puncturing in the encoding processing unit 1110. The certain value is set to, for example, zero.

The intermediate buffer 1244 stores the data subjected to the depuncturing in the depuncturer 1242 until the data is processed in the decoder 1246.

The decoder 1246 performs the error correction decoding by using the quantized data stored in the intermediate buffer 1244 to estimate the transmission data.

The CRC checker 1248 determines whether any error exists in the data decoded by the decoder 1246 by the CRC. If no error exists, the CRC checker 1248 instructs the ACK-NACK signal transmitter 1250 to notify the transmission apparatus 1100 of the ACK. If any error exists, the CRC checker 1248 instructs the ACK-NACK signal transmitter 1250 to nifty the transmission apparatus 1100 of the NACK.

The ACK-NACK signal transmitter 1250 transmits the ACK signal or the NACK signal to the transmission apparatus 1100 in accordance with the instruction from the CRC checker 1248.

### Exemplary Operation

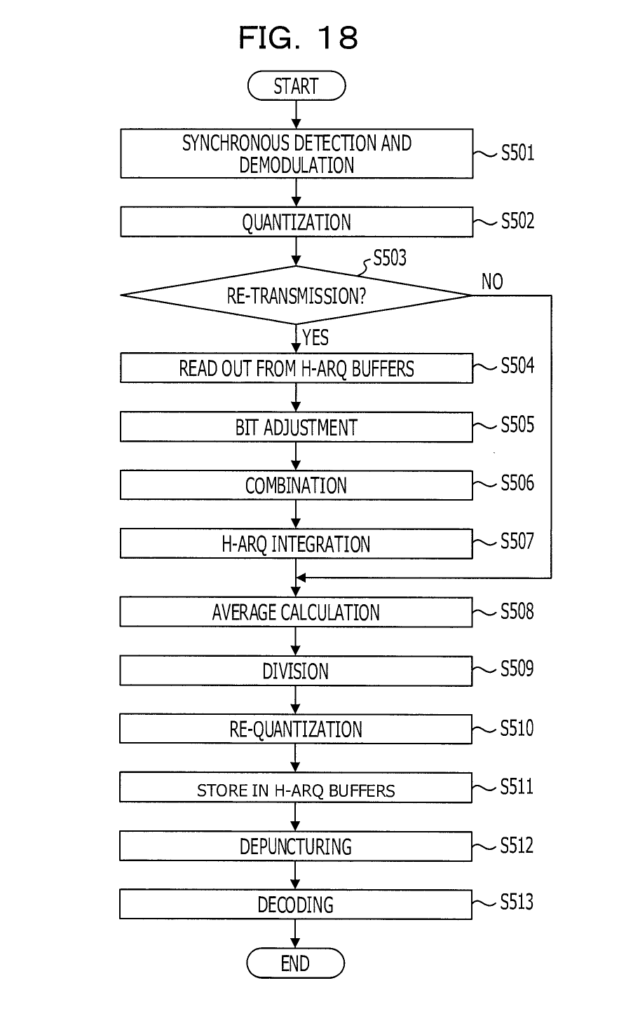

FIG. 18 is a flowchart illustrating an exemplary operational process performed by the reception apparatus of the fifth embodiment. The operational process in FIG. 18 is started, for example, upon reception of a signal by the reception apparatus 1200.

Referring to FIG. 18, in Step S501, the synchronous detector-demodulator 1202 performs the synchronous detection, the demodulation, and so on to a reception signal received through the antenna or the like. The reception symbol corresponding to the reception signal is acquired as a point on the IQ plane by the demodulation and so on. In addition, the synchronous detector-demodulator 1202 calculates the likelihood (the soft decision data) of each bit in all the reception symbols. The bit precision of the soft decision data is, for example, 32 bits. The likelihood of each bit is calculated by, for example, X0−X1, as described above.

In Step S502, the quantizer 1204 quantizes the likelihood of each bit in the reception symbol with a certain number of quantization bits. Here, the quantizer 1204 quantizes the likelihoods of all the bits with the same number of quantization bits. The data quantized by the quantizer 1204 is supplied to the H-ARQ integrator 1206.

In Step S503, the H-ARQ integrator 1206 determines whether the data supplied from the quantizer 1204 is the re-transmission data. If the data supplied from the quantizer 1204 is the re-transmission data (YES in Step S503), the process goes to Step S504. If the data supplied from the quantizer 1204 is not the re-transmission data (NO in Step S503), the H-ARQ integrator 1206 directly supplies the data supplied from the quantizer 1204 to the depuncturer 1242. Then, the process goes to Step S508.

If the data supplied from the quantizer 1204 to the H-ARQ integrator 1206 is the re-transmission data (YES in Step S503), in Step S504, the pieces of data corresponding to the data supplied from the quantizer 1204 is read out from the first H-ARQ buffer 1214 and the second H-ARQ buffer 1224.

In Step S505, the first bit adjuster 1216 performs the bit adjustment to the data read out from the first H-ARQ buffer 1214 and the second bit adjuster 1226 performs the bit adjustment to the data read out from the second H-ARQ buffer 1224. The bit adjustment is performed by, for example, inserting zero into a low-order digit of the data that is read out so that the digit (the number of bits) is aligned with the digit of the quantized data in the quantizer 1204.

In step S506, the combiner 1240 serially combines the data subjected to the bit adjustment in the first bit adjuster 1216 (the likelihood of the zeroth bit and the likelihood of the first bit) with the data subjected to the bit adjustment in the second bit adjuster 1226 (the likelihood of the second bit and the likelihood of the third bit). The combiner 1240 supplies the combined data to the H-ARQ integrator 1206.

In Step S507, the H-ARQ integrator 1206 integrates the data supplied from the quantizer 1204 with the data supplied from the combiner 1240. The H-ARQ integrator 1206 supplies the integrated data to the depuncturer 1242. The H-ARQ integrator 1206 supplies the integrated data to the average calculator 1208.

The average calculation (Step S508), the division (Step S509), and the re-quantization (Step S510) are similar to the average calculation (Step S102), the division (Step S103), and the quantization (Step S104) in the operational process of the first embodiment illustrated in FIG. 9. However, the data supplied from the H-ARQ integrator 1206 to the average calculator 1208 has already been quantized.

In Step S511, the first re-quantizer 1212 stores the quantized data in the first H-ARQ buffer 1214 and the second re-quantizer 1222 stores the quantized data in the second H-ARQ buffer 1224.

In Step S512, the depuncturer 1242 performs the depuncturing to the data input into the depuncturer 1242. Specifically, the depuncturer 1242 inserts a certain value (for example, zero) at a bit position decimated in the transmission apparatus 1100. The data processed in the depuncturer 1242 is temporarily stored in the intermediate buffer 1244.

In Step S513, the decoder 1246 performs the error correction decoding by using the quantized data stored in the intermediate buffer 1244 to estimate the transmission data. The CRC checker 1248 determines whether any error exists in the data decoded by the decoder 1246 by the CRC. If no error exists, the CRC checker 1248 instructs the ACK-NACK signal transmitter 1250 to notify the transmission apparatus 1100 of the ACK. If any error exists, the CRC checker 1248 instructs the ACK-NACK signal transmitter 1250 to nifty the transmission apparatus 1100 of the NACK. The ACK-NACK signal transmitter 1250 transmits the ACK signal or the NACK signal to the transmission apparatus 1100 in accordance with the instruction from the CRC checker 1248. Upon reception of the NACK signal, the transmission apparatus 1100 transmits the re-transmission data to the reception apparatus 1200.

### Effects and Advantages of Fifth Embodiment

The H-ARQ is applied to the reception apparatus 1200. The reception apparatus 1200 quantizes the bits in different sub-blocks with different numbers of quantization bits in the re-quantization of the data stored in the H-ARQ buffers. With the reception apparatus 1200, it is possible to reduce the capacities of the H-ARQ buffers by quantizing the bits in different sub-blocks with different numbers of quantization bits.

### Sixth Embodiment

A sixth embodiment will now be described. The configuration of the sixth embodiment has parts common to the configurations of the first embodiment, the second embodiment, the third embodiment, the fourth embodiment, and the fifth embodiment. Accordingly, different points are mainly described and a description of the common parts is omitted herein.

The H-ARQ is applied to a system of the sixth embodiment. An incremental redundancy (IR) scheme is used as the re-transmission method in the sixth embodiment. The same bit may be selected for part of the selected bit sequences that have been transmitted and different bits may be selected for part of them in the re-transmission. In addition, the bits that have been transmitted may be mapped to different positions in the modulation scheme in the re-transmission if their orders of transmission are varied. Accordingly, the distribution of the likelihoods of the bits may be varied for every transmission even if the bits have the same information.

Although the 64QAM in the second embodiment is exemplarily described in the sixth embodiment, the same applies to the 16QAM in the first embodiment.

### Exemplary Configuration

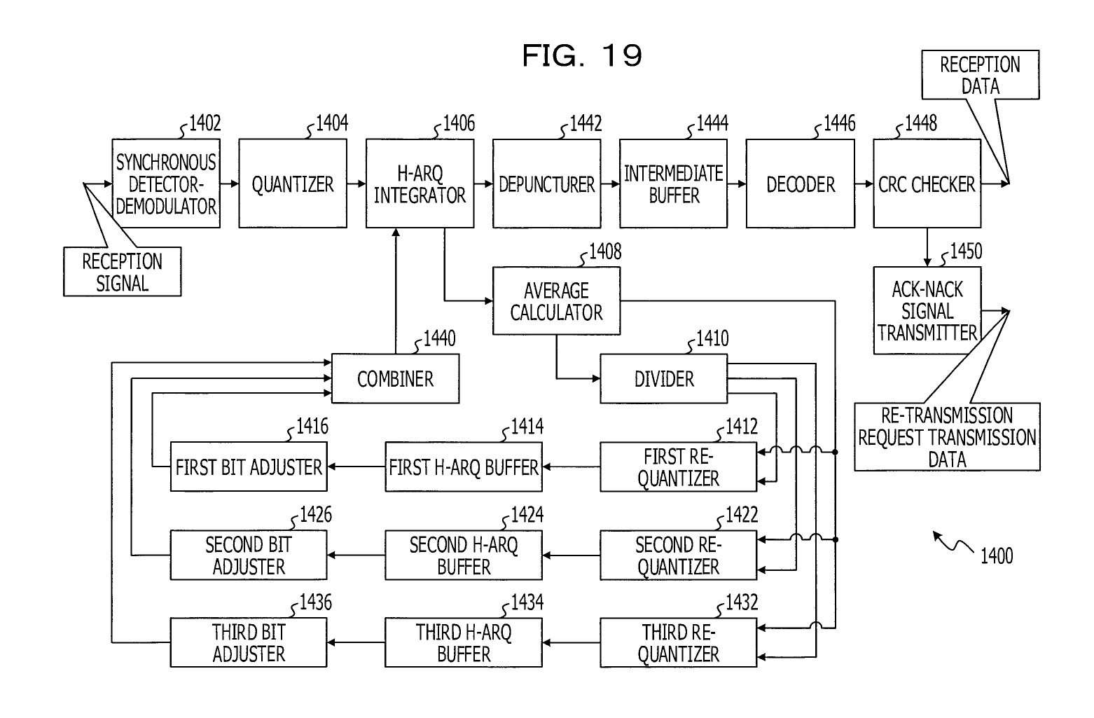

FIG. 19 illustrates an example of a reception apparatus of the sixth embodiment. Referring to FIG. 19, a reception apparatus 1400 has substantially the same configuration as that of the reception apparatus 1200 of the fifth embodiment to which the H-ARQ is applied. Specifically, the reception apparatus 1400 includes a synchronous detector-demodulator 1402, a quantizer 1404, an H-ARQ integrator 1406, an average calculator 1408, and a divider 1410. The reception apparatus 1400 also includes a first re-quantizer 1412, a first H-ARQ buffer 1414, a first bit adjuster 1416, a second re-quantizer 1422, a second H-ARQ buffer 1424, a second bit adjuster 1426, a third re-quantizer 1432, a third H-ARQ buffer 1434, a third bit adjuster 1436, and a combiner 1440. The reception apparatus 1400 further includes a depuncturer 1442, an intermediate buffer 1444, a decoder 1446, a CRC checker 1448, and an ACK-NACK signal transmitter 1450.

The average calculator 1408 calculates the average of the absolute values of the likelihoods of the respective bits supplied from the H-ARQ integrator 1406. The average calculator 1408 calculates the average of the absolute values in certain units. One reception symbol is divided into the first sub-block SB1 including the zeroth bit and the first bit, the second sub-block SB2 including the second bit and the third bit, and the third sub-block SB3 including the fourth bit and the fifth bit.

The average calculator 1408 determines the average of the absolute values×a first certain number to be the maximum likelihood value of the bits in the first sub-block SB1. The average calculator 1408 determines the average of the absolute values×a second certain number to be the maximum likelihood value of the bits in the second sub-block SB2. The average calculator 1408 determines the average of the absolute values×a third certain number to be the maximum likelihood value of the bits in the third sub-block SB3. The first certain number/the second certain number is a power of two (2ⁿ (n is an integer)). The first certain number/the third certain number is a power of two (2^{p} (p is an integer)). Provided that the average of the absolute values is denoted by A and the first certain number is denoted by B, the maximum likelihood value of the bits in the first sub-block SB1 is equal to A×B, the maximum likelihood value of the bits in the second sub-block SB2 is equal to A×B/2ⁿ, and the maximum likelihood value of the bits in the third sub-block SB3 is equal to A×B/2^{p}. For example, n is equal to one (n=1) and p is equal to two (p=2) here.

The maximum likelihood value of the bits in the first sub-block SB1, the maximum likelihood value of the bits in the second sub-block SB2, and the maximum likelihood value of the bits in the third sub-block SB3 determined by average calculator 1408 are supplied to the first re-quantizer 1412, the second re-quantizer 1422, and the third re-quantizer 1432, respectively.

If the data supplied to the average calculator 1408 does not include the re-transmission data (that is, the data is received for the first time), the number of quantization bits for the likelihood of each bit in the first sub-block SB1 is denoted by m, the number of quantization bits for the likelihood of each bit in the second sub-block SB2 is denoted by m−n, and the number of quantization bits for the likelihood of each bit in the third sub-block SB3 is denoted by m−p. The case in which the data supplied to the average calculator 1408 does not include the re-transmission data corresponds to a case in which the data supplied from the quantizer 1404 is not the re-transmission data. The above-mentioned m, n, and p are determined in advance on the basis of, for example, the sizes of the H-ARQ buffers and are stored in the storage unit or the like. The above-mentioned m, n, and p may be determined on the basis of the distribution of the likelihoods of the bits.

If the data supplied to the average calculator 1408 includes the re-transmission data (that is, the data is received for the second or subsequent time), the number of quantization bits for each sub-block is set to (m+(m−n)+(m−p))/3=(3×m−n−p)/3. is not equal to an integer, the maximum integer that does not exceed (3×m−n−p)/3 is set. The case in which the data supplied to the average calculator 1408 includes the re-transmission data corresponds to a case in which the data supplied from the quantizer 1404 is the re-transmission data.

The sum of the values of the data stored in the respective H-ARQ buffers when the data that does not include the re-transmission data is stored is the same as that when the data that includes the re-transmission data is stored.

### Effects and Advantages of Sixth Embodiment

The H-ARQ is applied to the reception apparatus 1400. The IR is applied to the reception apparatus 1400 as the re-transmission method. In the IR, part of the data to be re-transmitted is duplicated with the data that has been transmitted and part of the data to be re-transmitted is not duplicated with the data that has been transmitted. In addition, the position to which the bit in the duplicated data is mapped may be different from the position to which the bit in the data that has been transmitted is mapped. The reception apparatus 1400 quantizes the data in different sub-blocks with the different numbers of quantization bits in the re-quantization of the data that does not include the re-transmission data (the data that is transmitted for the first time). In addition, the reception apparatus 1400 quantizes all the bits with the same number of quantization bits in the re-quantization of the data that includes the re-transmission data. With the reception apparatus 1400, the application of different numbers of quantization bits to the data that does not include the re-transmission data for different sub-blocks allows the capacities of the H-ARQ buffers to be reduced.

Combinations of the embodiments described above may be implemented if possible.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A reception apparatus comprising:
a receiver configured to receive a symbol including a plurality of bits and to calculate each of likelihoods for each of the plurality of bits; and
a processor configured to quantize each of the likelihoods based on each of numbers of quantization bits for each of the plurality of bits;
wherein all of the numbers of quantization bits are not same.

2. The reception apparatus according to the claim 1,
wherein the processor is further configured to determine each of the numbers of quantization bits based on average of each of the likelihoods.

3. The reception apparatus according to the claim 1,
wherein the processor is further configured to divide the plurality of bits into sub blocks and to determine each of the numbers of quantization bits based on average of each of the likelihoods for each of the sub blocks.

4. The reception apparatus according to the claim 1,
wherein the processor is further configured to determine each of the numbers of quantization bits based on a coding rate of data including the symbol.

5. A reception apparatus comprising:
a receiver configured to receive a first symbol including a plurality of first bits, to calculate each of first likelihoods for each of the plurality of first bits, to receive a second symbol including a plurality of second bits, and to calculate each of second likelihoods for each of the plurality of second bits; and
a processor configured
to quantize each of the first likelihoods based on a specified numbers of quantization bits for each of the plurality of first bits, and to quantize each of the second likelihoods based on the specified numbers of quantization bits for each of the plurality of second bits,
to generate each of quantized likelihoods by quantizing each of the first likelihoods based on each of first numbers of quantization bits for each of the plurality of first bits, all of the first numbers of quantization bits being not same,
to generate each of adjusted likelihoods by making each of the first numbers of quantization bits for each of the quantized likelihoods equal to the specified numbers of quantization bits,
to generate combined likelihoods by combining each of the adjusted likelihoods, and
to integrate the combined likelihoods and the second likelihoods.

6. A reception method comprising:
receiving a symbol including a plurality of bits;
calculating each of likelihoods for each of the plurality of bits; and
quantizing, by a processor, each of the likelihoods based on each of numbers of quantization bits for each of the plurality of bits, all of the numbers of quantization bits being not same.

7. The reception method according to the claim 6, further comprising:
determining each of the numbers of quantization bits based on average of each of the likelihoods.

8. The reception method according to the claim 6, further comprising:
dividing the plurality of bits into sub blocks; and
determining each of the numbers of quantization bits based on average of each of the likelihoods for each of the sub blocks.

9. The reception method according to the claim 6, further comprising:
determining each of the numbers of quantization bits based on a coding rate of data including the symbol.
